(19) United States
(12) Patent Application Publication
(10) Pub. No.: US 2024/0224000 A1
(43) Pub. Date: Jul. 4, 2024

(54) APPARATUS, SYSTEM, AND METHOD OF BLUETOOTH AUDIO SHARING

(71) Applicant: INTEL CORPORATION, Santa Clara, CA (US)

(72) Inventors: Gila Kamhi, Zichron Yaakov (IL); Oren Haggai, Kefar Sava (IL); Prasanna Desai, Elfin Forest, CA (US)

(73) Assignee: INTEL CORPORATION, SANTA CLARA, CA (US)

(21) Appl. No.: 18/090,289

(22) Filed: Dec. 28, 2022

(51) Int. Cl. H04W 4/08; H04W 4/80; H04W 76/10

(52) U.S. Cl. CPC H04W 4/08; H04W 4/80; H04W 76/10

(57) ABSTRACT

For example, a Bluetooth (BT) device may be configured to identify metadata in broadcast messages received at the BT device from a plurality of BT audio source devices; and to select from the plurality of BT audio source devices at least one recommended BT audio source device for a user of the BT device for broadcast audio sharing with one or more other users in an audio sharing community of the user of the BT device. For example, the recommended BT audio source device may be selected from the plurality of BT audio source devices based on the metadata in the broadcast messages, and based on audio consumption information corresponding to the audio sharing community of the user of the BT device.

### TECHNICAL FIELD

Aspects described herein generally relate to Bluetooth audio sharing.

### BACKGROUND

A first Bluetooth device may be connected to and/or paired with a second Bluetooth device, for example, to transfer data between the first and second Bluetooth devices.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of operations and communications between Bluetooth (BT) devices, to demonstrate a technical problem, which may be addressed in accordance with some demonstrative aspects.

FIG. 3 is a schematic illustration of a BT audio source selection scheme, in accordance with some demonstrative aspects.

FIG. 4 is a schematic illustration of a BT audio sharing interface, in accordance with some demonstrative aspects.

FIG. 5 is a schematic illustration of a BT audio sharing mechanism, in accordance with some demonstrative aspects.

FIG. 6 is a schematic illustration of a BT audio sharing group recommendation mechanism, in accordance with some demonstrative aspects.

FIG. 7 is a schematic illustration of operations and communications between BT devices, in accordance with some demonstrative aspects.

FIG. 8 is a schematic flow-chart illustration of a method of BT audio sharing, in accordance with some demonstrative aspects.

FIG. 9 is a schematic flow-chart illustration of a method of BT audio sharing, in accordance with some demonstrative aspects.

FIG. 10 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Bluetooth (BT) device, a Bluetooth Low Energy (BLE) device, an audio device, a video device, an audio (A/V) device, a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing Bluetooth standards (“the Bluetooth standards”), e.g., including Bluetooth Core Specification V 5.3, Jul. 13, 2021, and/or future versions and/or derivatives thereof, devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks-Specific Requirements; Part 11: Wireless LAN Medium Access Control (MAC) and Physical Layer (PHY) Specifications, December, 2020)) and/or future versions and/or derivatives thereof, devices and/or networks operating in accordance with existing cellular specifications and/or protocols, units and/or devices which are part of the above networks, and the like.

Some aspects may be used in conjunction with one way and/or two-way radio communication systems, a Bluetooth system, a BLE system, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), Extended GPRS, Code-Division Multiple Access (CDMA), Wideband CDMA (WCDMA), CDMA 2000, single-carrier CDMA, multi-carrier CDMA, Multi-Carrier Modulation (MCM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G), or Sixth Generation (6G) mobile networks, 3GPP, Long Term Evolution (LTE), LTE Advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that is integrated with a computer, or a peripheral that is attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a frequency band of 2.4 GHz, 5 GHZ, or 6 GHz. However, other aspects may be implemented utilizing any other suitable wireless communication frequency bands, for example, an Extremely High Frequency (EHF) band (the millimeter wave (mmWave) frequency band), e.g., a frequency band within the frequency band of between 20 GHz and 300 GHz, a WLAN frequency band, a WPAN frequency band, and the like.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

Some demonstrative aspects are described herein with respect to BT communication, e.g., according to a BT protocol and/or a BLE protocol. However, other aspects may be implemented with respect to any other communication scheme, network, standard and/or protocol.

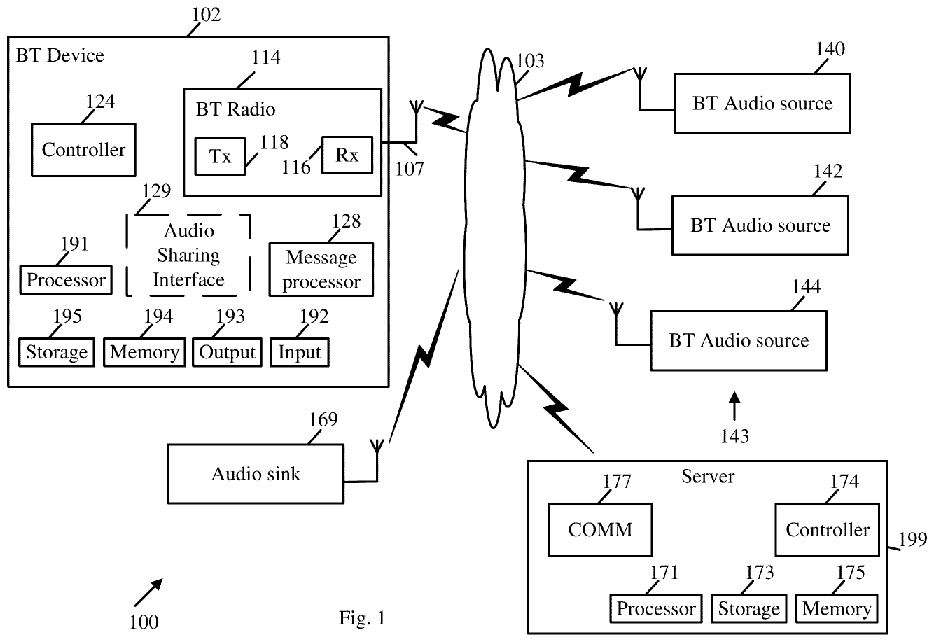

Reference is now made to FIG. 1, which schematically illustrates a block diagram of a system 100, in accordance with some demonstrative aspects.

As shown in FIG. 1, in some demonstrative aspects system 100 may include a wireless communication network including one or more wireless communication devices, e.g., including wireless communication devices 102, 169, and/or 143.

In some demonstrative aspects, system 100 may include a server 199, which may be configured to perform one or more operations and/or functionalities, for example, to provide one or more services to wireless communication devices 102, 169, and/or 143, e.g., as described below.

In some demonstrative aspects, server 199 may be implemented as, and/or may be configured to perform one or more operations and/or functionalities of, a remote server, a web-based server, a cloud server, a cloud service, and/or any other server. In other aspects, server 199 may be implemented as, and/or may be configured to perform one or more operations and/or functionalities of, any other type of server and/or service provider.

In some demonstrative aspects, wireless communication devices 102, 169 and/or 143 may include, for example, a computing device, UE, an MD, a STA, a PC, a desktop computer, a mobile computer, a laptop computer, an Ultrabook™ computer, a Smartphone, a gaming device, a peripheral device, a notebook computer, a tablet computer, a server computer, a handheld computer, an Internet of Things (IoT) device, a sensor device, a handheld device, a wearable device, an on-board device, an off-board device, a consumer device, a vehicular device, a non-vehicular device, a mobile or portable device, a non-mobile or non-portable device, a mobile phone, a cellular telephone, a video device, an audio device, an A/V device, a video source, an audio source, a video sink, an audio sink, a Personal Media Player (PMP), a digital audio player, a gaming device, a data source, a data sink, a media player, or the like.

In some demonstrative aspects, devices 102, 169 and/or 143 may include, operate as, and/or perform the functionality of one or more BT devices.

In some demonstrative aspects, device 102, device 169 and/or one or more of devices 143 may include a BT mobile device. In other aspects, device 102, device 169 and/or one or more of devices 143 may include a non-mobile BT device.

In one example, devices 102, 169 and/or 143 may include BT Low Energy (LE) (BLE) compatible devices. In other aspects, devices 102, 169 and/or 143 may include or implement any other additional or alternative BT communication functionality, e.g., according to any other additional or alternative BT protocol.

In some demonstrative aspects, devices 102, 169 and/or 143 may include, operate as, and/or perform the functionality of one or more STAs. For example, device 102 may include at least one STA, device 169 may include at least one STA, and/or devices 143 may include at least one STA.

In some demonstrative aspects, devices 102, 169 and/or 143 may include, operate as, and/or perform the functionality of one or more WLAN STAs.

In some demonstrative aspects, devices 102, 169 and/or 143 may include, operate as, and/or perform the functionality of one or more Wi-Fi STAs.

In one example, a station (STA) may include a logical entity that is a singly addressable instance of a medium access control (MAC) and physical layer (PHY) interface to the wireless medium (WM). The STA may perform any other additional or alternative functionality.

In other aspects, devices 102, 169 and/or 143 may include, operate as, and/or perform the functionality of any other type of STA and/or device.

In some demonstrative aspects, device 102 may include, for example, one or more of a processor 191, an input unit 192, an output unit 193, a memory unit 194, and/or a storage unit 195. Device 102 may optionally include other suitable hardware components and/or software components. In some demonstrative aspects, some or all of the components of device 102 may be enclosed in a common housing or packaging, and may be interconnected or operably associated using one or more wired or wireless links. In other aspects, components of device 102 may be distributed among multiple or separate devices.

In some demonstrative aspects, server 199 may include, for example, one or more of a processor 171, a memory unit 175, and/or a storage unit 173. Server 199 may optionally include other suitable hardware components and/or software components. In some demonstrative aspects, some or all of the components of server 199 may be enclosed in a common housing or packaging, and may be interconnected or operably associated using one or more wired or wireless links. In other aspects, components of server 199 may be distributed among multiple or separate devices.

In some demonstrative aspects, processor 191 and/or processor 171 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 executes instructions, for example, of an Operating System (OS) of device 102 and/or of one or more suitable applications. Processor 171 executes instructions, for example, of an OS of server 199 and/or of one or more suitable applications.

In some demonstrative aspects, input unit 192 may include, for example, a keyboard, a keypad, a mouse, a touch-screen, a touch-pad, a track-ball, a stylus, a microphone, or other suitable pointing device or input device. Output unit 193 includes, for example, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 175 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage 173 includes, for example, a hard disk drive, a floppy disk drive, a Compact Disk (CD) drive, a CD-ROM drive, a DVD drive, or other suitable removable or non-removable storage units. Memory unit 194 and/or storage unit 195, for example, may store data processed by device 102. Memory unit 175 and/or storage unit 173, for example, may store data processed by server 199.

In some demonstrative aspects, wireless communication devices 102, 169, and/or 143, and/or server 199, may be capable of communicating content, data, information and/or signals via a wireless medium (WM) 103.

In some demonstrative aspects, wireless medium 103 may include, for example, a BT channel, a radio channel, a cellular channel, a Global Navigation Satellite System (GNSS) Channel, an RF channel, a WiFi channel, an IR channel, and the like.

In some demonstrative aspects, wireless communication medium 103 may include a 2.4 GHz frequency band, and/or one or more other wireless communication frequency bands, for example, a 5 GHz frequency band, a 6 GHz frequency band, a millimeterWave (mmWave) frequency band, e.g., a 60 GHz frequency band, a Sub-1 GHz (S1G) band, and/or any other frequency band.

In some demonstrative aspects, device 169 may include a BT audio sink device, which may be connected to, associated with, and/or paired to, device 102. For example, BT audio sink device 169 may include a headset, earphones, a hearing aid, and/or any other device configured to output audio to a user of the BT audio sink device 169.

In some demonstrative aspects, devices 143 may include a plurality of BT audio source devices, e.g., including a BT audio source device 140, a BT audio source device 142, and/or a BT audio source device 144. For example, BT audio source devices 143 may be configured as BT audio broadcast devices, which may broadcast audio streams via BT communication, e.g., as described below.

In some demonstrative aspects, server 199 may include at least one communication interface 177, which may be configured to communicate with users of one or more BT devices in system 100, e.g., device 102, with one or more of the BT audio source devices 143, and/or with one or more other devices and/or elements in system 100, e.g., as described below.

In some demonstrative aspects, the at least one communication interface 177 may include at least one wired communication interface to communicate over one or more wired communication networks, and/or at least one wireless communication interface to communicate over one or more wireless networks, e.g., as described below.

In some demonstrative aspects, devices 102, 169 and/or 143 may include one or more BT radios including circuitry and/or logic to perform wireless communication between devices 102, 169, 143 and/or one or more other BT devices. For example, device 102 may include at least one BT radio 114.

In some demonstrative aspects, devices 102, 169, and/or 143 may include one or more other radios, e.g., a WiFi radio, an OFDM radio, a cellular radio, and/or the like.

In some demonstrative aspects, BT radio 114 may include one or more wireless receivers (Rx) including circuitry and/or logic to receive wireless communication signals, RF signals, frames, blocks, transmission streams, packets, messages, data items, and/or data. For example, radio 114 may include at least one receiver 116.

In some demonstrative aspects, BT radio 114 may include one or more wireless transmitters (Tx) including circuitry and/or logic to transmit wireless communication signals, RF signals, frames, blocks, transmission streams, packets, messages, data items, and/or data. For example, radio 114 may include at least one transmitter 118.

In some demonstrative aspects, BT radio 114, transmitter 118, and/or receiver 116 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like.

In some demonstrative aspects, BT radio 114 may be configured to communicate over a 2.4 GHz band, and/or any other band.

In some demonstrative aspects, BT radio 114 may include, or may be associated with, one or more antennas. For example, BT radio 114 may include, or may be associated with, one or more antennas 107.

For example, antennas 107 may include any type of antennas suitable for transmitting and/or receiving wireless communication signals, blocks, frames, transmission streams, packets, messages and/or data. For example, antennas 107 may include any suitable configuration, structure and/or arrangement of one or more antenna elements, components, units, assemblies and/or arrays. In some aspects, antennas 107 may implement transmit and receive functionalities using separate transmit and receive antenna elements. In some aspects, antennas 107 may implement transmit and receive functionalities using common and/or integrated transmit/receive elements.

In some demonstrative aspects, device 102 may include a controller 124 configured to perform and/or to trigger, cause, instruct and/or control device 102 to perform, one or more communications, to generate and/or communicate one or more messages and/or transmissions, and/or to perform one or more functionalities, operations and/or procedures between devices 102, 169, 143 and/or one or more other devices, e.g., as described below.

In some demonstrative aspects, controller 124 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controller 124. Additionally or alternatively, one or more functionalities of controller 124 may be implemented by logic, which may be executed by a machine and/or one or more processors, e.g., as described below.

In one example, controller 124 may include circuitry and/or logic, for example, one or more processors including circuitry and/or logic, to cause, trigger and/or control a BT audio device, e.g., device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, message processor 128 may include circuitry and/or logic, e.g., processor circuitry and/or logic, memory circuitry and/or logic, MAC circuitry and/or logic, PHY circuitry and/or logic, and/or any other circuitry and/or logic, configured to perform the functionality of message processor 128. Additionally or alternatively, one or more functionalities of message processor 128 may be implemented by logic, which may be executed by a machine and/or one or more processors, e.g., as described below.

In some demonstrative aspects, at least part of the functionality of message processor 128 may be implemented as part of controller 124. In other aspects, the functionality of message processor 128 may be implemented as part of any other element of device 102.

In some demonstrative aspects, controller 124 may be implemented as part of, and/or may be configured to perform one or more operations and/or functionalities of a host processor of device 102.

In some demonstrative aspects, controller 124 may be implemented as part of, and/or may be configured to perform one or more operations and/or functionalities of a BT controller of device 102.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of BT radio 114. For example, the chip or SoC may include one or more elements of controller 124, one or more elements of message processor 128, and/or one or more elements of BT radio 114. In one example, controller 124, message processor 128, and BT radio 114 may be implemented as part of the chip or SoC.

In some demonstrative aspects, at least part of the functionality of controller 124 and/or message processor 128 may be implemented by a host processor of device 102.

In other aspects, controller 124, message processor 128 and/or BT radio 114 may be implemented by one or more additional or alternative elements of device 102.

In some demonstrative aspects, server 199 may include a controller 174 configured to perform and/or to trigger, cause, instruct and/or control server 199 to perform one or more communications, to generate and/or communicate one or more messages and/or transmissions, and/or to perform one or more functionalities, operations and/or procedures between server 199 and devices 102, 169, 143 and/or one or more other devices, e.g., as described below.

In some demonstrative aspects, controller 174 may include, or may be implemented, partially or entirely, by circuitry and/or logic, e.g., one or more processors including circuitry and/or logic, memory circuitry and/or logic, configured to perform one or more functionalities of controller 174. Additionally or alternatively, one or more functionalities of controller 174 may be implemented by logic, which may be executed by a machine and/or one or more processors, e.g., as described below.

In one example, controller 174 may include circuitry and/or logic, for example, one or more processors including circuitry and/or logic, to cause, trigger and/or control a server, e.g., server 199, to perform one or more operations, communications and/or functionalities, e.g., as described herein. In one example, controller 174 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 174 may be implemented by a host processor of server 199.

In other aspects, controller 174 may be implemented by one or more additional or alternative elements of server 199.

In some demonstrative aspects, device 102, device 169, devices 143, and/or server 199 may be configured to implement one or more functionalities and/or operations according to a wireless audio streaming technology, for example, a Bluetooth Low Energy (BLE) Audio technology, e.g., as described below.

In some demonstrative aspects, device 102, device 169, devices 143, and/or server 199 may be configured to implement one or more functionalities and/or operations according to a wireless audio streaming technology, which may support multi-stream audio, BT “broadcasting”, e.g., the ability to “broadcast” via Bluetooth to multiple devices, integration with hearing aid devices for enhanced seamless accessibility options, and/or one or more other features and/or mechanisms.

For example, device 102, device 169, devices 143, and/or server 199 may be configured to implement one or more functionalities and/or operations, which may support a technical solution to support connection of a BT device to multiple sources, e.g., simultaneously. For example, device 102, device 169, devices 143, and/or server 199 may be configured to implement one or more functionalities and/or operations, e.g., in accordance with a BT LE Audio protocol, to connect a single BT device, e.g., a single pair of headphones, for example, audio sink device 169, to multiple audio sources transmitted by multiple devices, e.g., simultaneously. In one example, this ability may be implemented to support various use cases, for example, such as listening to a baby monitor, taking a phone call, and/or using a smart assistant, e.g., all from one set of Bluetooth headphones.

For example, device 102, device 169, devices 143, and/or server 199 may be configured to implement one or more functionalities and/or operations, which may support a technical solution utilizing broadcast Bluetooth audio to support an ability to serve source audio to multiple Bluetooth listening devices, e.g., similar to a Wi-Fi broadcast.

For example, a BT device, e.g., device 102, may be configured to scan for one or more BT audio broadcast sources, for example, at a public space or a private space, e.g., an airport, a mall, a museum, a building, an office, or the like, and to select and listen to one or more audio streams broadcasted from the BT audio broadcast sources, e.g., as described below.

In one example, a BT audio broadcast source of BT audio sources 143 may be configured to protect, e.g., passcode-protect, an audio stream, for example, to support a solution to broadcast privately to one or more users. In another example, a BT audio broadcast source may be configured to broadcast an “open” audio stream, which may be accessible by anyone who wants to listen.

In one example, a BT device, e.g., device 102, may be configured to scan for one or more BT audio broadcast sources, for example, to tune into foreign language audio tracks at a movie theater.

In another example, a BT device, e.g., device 102, may be configured to scan for one or more BT audio broadcast sources, for example, to allow a user to listen to the sound of a silenced TV, e.g., at an airport lounge, through the user's earphones.

In another example, a BT device, e.g., device 102, may be configured to scan for one or more BT audio broadcast sources, for example, at a sightseeing tour, e.g., at a museum, to allow a user of the BT device to enjoy the tour guide's audio over the user's own headphones.

For example, device 102, device 169, devices 143, and/or server 199 may be configured to implement one or more functionalities and/or operations, which may support a technical solution for better accessibility for people with hearing loss. For example, device 102, device 169, devices 143, and/or server 199 may be configured to implement one or more functionalities and/or operations to supports hearing aid development standards, and/or to make it possible to pass audio directly from an audio source to a hearing aid, or even to a whole room full of people with hearing aids.

In some demonstrative aspects, in some use cases, scenarios, implementations and/or deployments, there may be a need to address a technical problem with respect to discoverability of BT audio sharing channels, e.g., as described below.

For example, there may be a need to address a technical problem with respect to how will people know that a broadcast audio stream is available, and/or what should a user do with respect to such broadcast audio stream. For example, there may be a need to provide a technical solution to notify a general audience at a location that a BT broadcast is available, e.g., at least until people get used to scanning for BT broadcast audio sources.

For example, as there may be more and more BT LE audio share streams available, there may be a need to provide a technical solution to allow to selectively and/or automatically connect a user to one or more audio share channels that are potentially of interest to him/her. In one example, there may be a need to provide a technical solution to support seamless connection and/or disconnection of a BT device to/from channels that address one or more listening needs of a user of the BT device. For example, such a solution may allow to leverage BT audio share features.

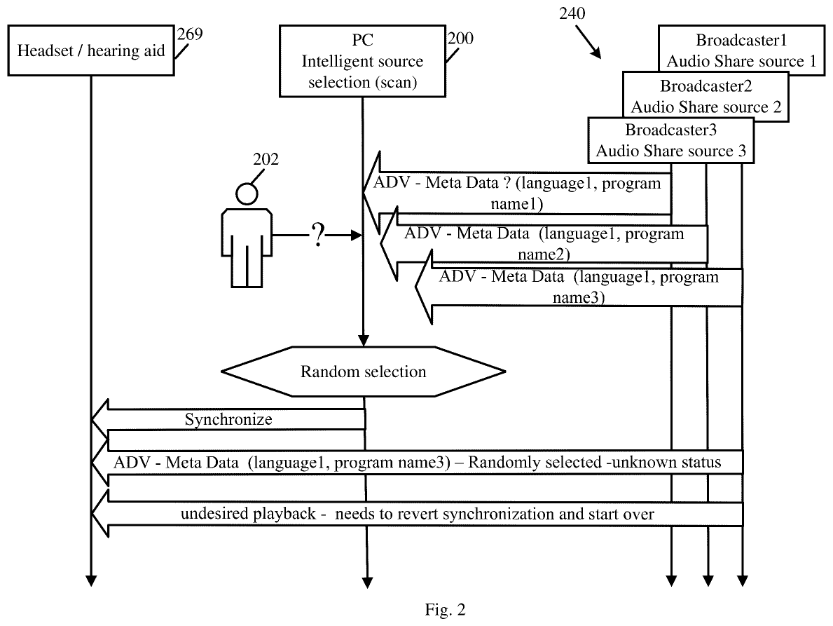

Reference is made to FIG. 2, which schematically illustrates operations and communications between BT devices, to demonstrate a technical problem, which may be addressed in accordance with some demonstrative aspects.

For example, as shown in FIG. 2, a BT device 200 may be configured to scan for broadcasts from BT audio source devices 240. For example, the BT device 200 may include a computing device, e.g., a mobile computing device, smartphone, or the like, which may be connected to, or associated with, an audio sink device 269, e.g., a headset, an earphone, a hearing aid, or the like.

For example, as shown in FIG. 2, broadcasts from BT audio source devices 240 may include a minimal set of metadata attributes, for example, to identify the source language and/or program name of a broadcast audio stream. This information provided by the BT audio source devices 240 may not be enough for a given user to be able to make a decision, e.g., a conscious and/or informed decision, to which BT audio source device 240 to synchronize (sync).

For example, as shown in FIG. 2, a user 202 of the BT device 200 may be required to manually and/or randomly select an audio source from the BT audio source devices 240 to which to synchronize the audio sink device 269. As a result, the user 202 may sync to the selected audio source, just to seek and then listen to content, only to find that it is not the content the user 202 was looking for. Accordingly, the user 202 may need to switch to a next audio source, e.g., for several times, until the user 202 may find a suitable audio source. This process may result in a poor user experience, as the number of audio sources in an area can be very large, e.g., over a dozen, and the user 202 may encounter new audio sources 240, e.g., as the user 202 moves from one location to another location.

Referring back to FIG. 1, in some demonstrative aspects, device 102 and/or server 199 may be configured to implement an intelligent audio share content selection mechanism to select one or more BT audio sources for a BT connection, e.g., as described below.

In some demonstrative aspects, the intelligent audio share content selection mechanism may be configured to score and/or rank audio share content sources, e.g., which may be most relevant for a user of BT device 102 to connect to, as described below.

In some demonstrative aspects, the intelligent audio share content selection mechanism may be configured to utilize a user audio share profile, which may be configured based on personal activities and/or preferences of the user of BT device 102, e.g., as described below.

In some demonstrative aspects, the intelligent audio share content selection mechanism may be configured to utilize dynamic, e.g., relevant, contextual data relating to one or more current activities of the user of the BT device 102, e.g., as described below.

In some demonstrative aspects, the intelligent audio share content selection mechanism may be configured to utilize an audio share popularity score, which may be based on one or more audio-sharing preferences and/or activities of the user of BT device 102, e.g., as described below.

In some demonstrative aspects, one or more functionalities of the intelligent audio share content selection mechanism may be implemented as part of a BT LE audio protocol stack, for example, with an interface to an OS of a device, e.g., device 102, for example, in a way which may support the device, e.g., device 102, to be a router of audio from one or more BT audio sources 143 at its vicinity to one or more audio sinks (hearables) 169, e.g., earbuds, hearing aids or the like.

In some demonstrative aspects, the intelligent audio share content selection mechanism may be configured to leverage meta data, e.g., indicative of people currently listening to specific audio share content, for example, to creates personalized suggestions for the user of device 102 on which content to audio share, e.g., as described below.

In some demonstrative aspects, the intelligent audio share content selection mechanism may be configured to determine the personalized suggestions for the user of device 102, for example, by taking into consideration a BT LE audio share community of the user, and/or actual listeners of BT Audio Share content, e.g., as described below.

In some demonstrative aspects, the intelligent audio share content selection mechanism may be configured to provide a technical solution, which may potentially change the way users may create and/or consume audio, and/or social behavior in public venues, e.g., as described below.

In some demonstrative aspects, controller 124 may be configured to provide to the user of device 102 information one or more, e.g., some or all, BT audio broadcasts in a vicinity of device 102, for example, based on a BT scan for BT audio source devices 143 at a location of the device 102, e.g., as described below.

In some demonstrative aspects, one or more functionalities and/or operations of controller 124 may be implemented by a BT audio application, for example, a BT audio share scan app, which may be executed by device 102. In one example, the BT audio application may be implemented as part of a BT LE Audio sharing application, and/or any other application.

For example, the BT audio application may be configured to provide to a user of an audio sink device 169, e.g., earphones or a headset, information on “all the BT audio broadcasts near you”.

In some demonstrative aspects, the BT audio application may include, or may be implemented as, software, a software module, an application, a program, a subroutine, instructions, an instruction set, computing code, words, values, symbols, and the like.

In some demonstrative aspects, the BT audio application may include a local application to be executed by device 102. For example, memory unit 194 and/or storage unit 195 may store instructions resulting in the BT audio application, and/or processor 191 may be configured to execute the instructions resulting in the BT audio application and/or to perform one or more calculations and/or processes of the BT audio application.

In other aspects, one or more functionalities and/or operations of the BT audio application may include a remote application to be executed by any suitable computing system, e.g., by controller 174 of server 199.

In some demonstrative aspects, device 102 may communicate with server 199, for example, via network 103.

In some demonstrative aspects, the BT audio application may be implemented as a combination of a remote application and a local application.

In one example, the BT audio application may be downloaded and/or received by the user of device 102 from another computing system, e.g., server 199, such that the BT audio application may be executed locally by the user of device 102. For example, the instructions may be received and stored, e.g., temporarily, in a memory or any suitable short-term memory or buffer of device 102, e.g., prior to being executed by processor 191 of device 102.

In another example, the BT audio application may include a front-end to be executed locally by device 102, and a backend to be executed by server 199. For example, the front end may include and/or may be implemented as a local application, a web application, a web site, a web client, e.g., a Hypertext Markup Language (HTML) web application or the like.

For example, one or more first operations of the BT audio application may be performed locally, for example, by device 102, and/or one or more second operations of the BT audio application may be performed remotely, for example, by server 199.

In other aspects, one or more functionalities and/or operations of controller 124 may be implemented by any other additional or alternative elements and/or components of device 102.

In some demonstrative aspects, controller 124 may be configured to implement an audio-source selection mechanism to select one or more of BT audio sources 143 for establishing a BT connection, e.g., as described below.

In some demonstrative aspects, the audio-source selection mechanism may be configured to enhance usability and/or discoverability of audio sharing streams, for example, as more BT LE audio share streams become available.

For example, the audio-source selection mechanism may be configured to provide a technical solution for intelligent and/or automatic selection/filtering of audio BT sharing streams for a potential user or users, e.g., based on contextual and/or personal criteria, as described below.

In some demonstrative aspects, controller 124 may be configured to implement the audio-source selection mechanism to support a technical solution to allow the user of audio sink device 169, e.g., headphones and/or a hearing aid, to automatically listen to a relevant audio share source in the user's vicinity, e.g., while taking into consideration personal, social and/or contextual data for the user, e.g., as described below.

In some demonstrative aspects, the audio-source selection mechanism may be configured to implement automatic selection of one or more audio share sources for a particular group of people, e.g., users in “my close circle”, as described below.

In some demonstrative aspects, device 102 and/or server 199 may be configured to implement an audio sharing mechanism (also referred to as “BT audio sharing” or “BT audio share”), which may be configured to provide a technical solution to support the use of wireless audio streaming technologies, e.g., BT audio streaming, for example, to enhance a way we experience audio/media with friends/close family or people that share our interests, e.g., a music concert, and/or needs, e.g., a history class.

In some demonstrative aspects, the BT audio sharing mechanism may be configured to provide a technical solution to support connection of BT devices, e.g., BT device 102, to multi-stream audio, which may be “broadcast” via BT to multiple devices, e.g., as described below.

In some demonstrative aspects, the BT audio sharing mechanism may be configured to provide a technical solution to support enhanced accessibility options for BT audio content sharing, e.g., as described below.

In some demonstrative aspects, the BT audio sharing mechanism may be configured to provide a technical solution to enhance the way multiple users experience audio/media content together, e.g., as described below.

In some demonstrative aspects, the BT audio sharing mechanism may be configured to provide a technical solution to support a social listening experience, for example, based on discovery/adaptation and/or group recommendation functionalities, which may be based on, and/or triggered by, a group of people listening at the same time, e.g., at the same location, to the same content, for example, via a BT LE Audio sharing feature, e.g., as described below.

In some demonstrative aspects, the BT audio sharing mechanism may be configured to utilize information of choices made by users with respect to BT audio/media share content, e.g., concert, news channel, history class, football game, or the like, for example, as a source of information on personal interests, hobbies, or the like. For example, this information of personal interests may be used to define a user profile for a user, which may be used to recommend audio content to be consumed by the user, e.g., as described below.

In some demonstrative aspects, the BT audio sharing mechanism may be configured to identify and/or collect information on the people who simultaneously share content, for example, as an information source, which may be used, for example, to support sharing of audio content by multiple users, e.g., via BT LE Audio, as described below.

For example, in many use cases and/or scenarios, people who consistently audio share, e.g., watch movies, listen to podcasts, attend classes, or the like, may share experiences together. For example, a group of users, e.g., friends, classmates, co-workers, or the like, may share the same interests in audio content.

In some demonstrative aspects, the BT audio sharing mechanism may be configured to identify, select, offer and/or recommend to a user of a BT device, e.g., device 102, audio share content that is customized to a community (also referred to as “audio share community” or “audio sharing group”) associated with the user, e.g., as described below.

In some demonstrative aspects, the BT audio sharing mechanism may be configured to customize the recommended audio content to the community of the user, for example, in addition to, or instead of, customizing the recommended audio content based on one or more personalization criteria. For example, the personalization criteria may be configured to personalize the recommended audio content to the needs and interests of a single user.

In some demonstrative aspects, the BT audio sharing mechanism may be configured to characterize the audio share community of a particular content that is being broadcast at a particular location, e.g., as described below.

In some demonstrative aspects, the BT audio sharing mechanism may be configured to support on-line adaptation of audio share content, e.g., in real time, for example, to address the needs of users participating in a current audio share session, e.g., participants in a close circle of a user currently consuming audio content from a BT audio source, as described below.

In some demonstrative aspects, the BT audio sharing mechanism may be configured to adjust one or more attributes of a particular content that is being broadcast at a particular location, for example, based on an audio sharing group, which is consuming the particular content, e.g., as described below.

In some demonstrative aspects, the BT audio sharing mechanism may be configured to adjust one or more attributes of the particular content that is being broadcast at a particular location, for example, to provide a technical solution to increase user satisfaction and/or audio share community satisfaction, for example, by leveraging a multi-streaming feature, e.g., as described below.

In some demonstrative aspects, the BT audio sharing mechanism may be configured to define and/or manage an audio share community, which may be driven, for example, by content and/or users, e.g., as described below.

In some demonstrative aspects, an audio share community may be defined, for example, based on a combination of a content-driven audio sharing feature and a user-driven audio sharing feature, e.g., as described below.

In some demonstrative aspects, the content-driven audio sharing may include sharing of a particular content by multiple users, for example, all people who listen to a particular audio content, e.g., a news channel.

In some demonstrative aspects, the user-driven audio sharing may include audio sharing based on a community associated with a user.

For example, a content-audio share community for a particular audio content, e.g., a news channel X—audio share community, may include people who get connected to the particular audio content, e.g., the news channel X, at a particular location. For example, a user-audio share community of a user, e.g., “My audio share community”, may include a community of people, e.g., a close circle of people, who connect to the same audio share content with the user.

For example, people who simultaneously share the same content may have similar but different needs. In one example, audio content may be delivered at the native language of each audio share participant. For example, ideally, the audio share content may be adapted to serve the needs/likes of people who are currently connected and listening.

For example, multi-streaming capabilities of BT LE Audio may be leveraged in the adaptation of audio share content, e.g., ideally. For example, variations (versions) of the audio content may be streamed based on needs/like of the audio share community (circle) of a particular content, e.g., language of a silent TV broadcast at a public venue, the level of an education content, or the like, e.g., as described below.

In some demonstrative aspects, the BT audio sharing mechanism may be configured to provide a technical solution to support BT Audio share communities in creating new social experiences, for example, by prioritizing and/or offering a user to get connected to a same audio share channel, which may be shared with other users who are, for example, at close proximity to the user, and/or who are, for example, members of the user's audio share community (circle), e.g., as described below.

In some demonstrative aspects, the BT audio sharing mechanism may be configured to provide a technical solution to provide the user with notifications on users/friends that are connected to the same audio share stream, and/or to allow the user to be in touch with these users/friends, e.g., as described below.

In some demonstrative aspects, the BT audio sharing mechanism may be configured to implement a BT audio sharing interface, for example, to support communication between the users who are sharing the BT audio content, e.g., in real time.

For example, the BT audio sharing interface may be implemented as a BT audio conferencing application, e.g., having one or more functionalities similar to a video/phone conferencing application, e.g., as described below.

For example, the BT audio sharing interface may be configured to implement messaging, e.g., text messages, to allow participants of an audio sharing session to discuss and/or share feedback on the content that is being observed, e.g., as described below.

In some demonstrative aspects, the BT audio sharing interface may be configured to provide a technical solution to support collaborative listening and/or an enhanced social audio share experience, e.g., as described below.

In some demonstrative aspects, the BT audio sharing interface may be configured to provide a technical solution to support participants of an audio share session to actively provide feedback and/or communicate during the audio share session, e.g., as described below.

For example, the feedback provided by the participants of the audio share session may be saved and learned, for example, to adapt the audio content, e.g., in order to improve user satisfaction for future streaming.

In some demonstrative aspects, BT device 102 and/or server 199 may be configured to implement an audio share content source selection mechanism (“Audio Share Community Driven Audio Share Content Selection”), which may be based on, and/or driven by, a selection criterion relating to an audio share community of the user of BT device 102, e.g., as described below.

In some demonstrative aspects, BT device 102 and/or server 199 may be configured to implement an audio share content source selection mechanism, which may be configured to select from the plurality of BT audio source devices 143 one or more recommended BT audio source devices for a BT audio connection for the user of device 102, for example, based on an audio share community of the user of BT device 102, e.g., as described below.

In some demonstrative aspects, BT device 102 and/or server 199 may be configured to implement an audio share content source selection mechanism, which may be based on a selection criterion, which takes into consideration one or more audio share community group preferences and/or needs, for example, in order to select the one or more recommended BT audio source devices from the plurality of BT audio source devices 143, e.g., as described below.

In some demonstrative aspects, controller 124 may be configured to cause, control, trigger, and/or instruct BT device 102 to identify metadata in broadcast messages received at the BT device 102 from the plurality of BT audio source devices 143, e.g., as described below.

In some demonstrative aspects, a broadcast message from a BT audio source device of BT audio source devices 143 may include metadata indicating one or more attributes of audio data broadcasted by the BT audio source device.

For example, BT audio source device 140 may be configured to broadcast a broadcast message including metadata indicating one or more attributes of audio data broadcasted by the BT audio source device 140, BT audio source device 142 may be configured to broadcast a broadcast message including metadata indicating one or more attributes of audio data broadcasted by the BT audio source device 142, and/or BT audio source device 144 may be configured to broadcast a broadcast message including metadata indicating one or more attributes of audio data broadcasted by the BT audio source device 144.

For example, the audio data broadcasted from BT audio source device 140 may be different from the audio data broadcasted from BT audio source device 142 and/or the audio data broadcasted from BT audio source device 144.

For example, the metadata in the broadcast message from BT audio device 140 may include information, which may be configured to allow to differentiate between the audio data broadcasted from BT audio source device 140, the audio data broadcasted from BT audio source device 142 and/or the audio data broadcasted from BT audio source device 144, e.g., as described below.

For example, the metadata in the broadcast message from BT audio device 140 may include information, which may be configured to allow to determine whether the audio data broadcasted from BT audio source device 140 meets one or more criteria with respect to audio data to be provided to the user of BT device 102, e.g., as described below.

In some demonstrative aspects, controller 124 may be configured to cause, control, trigger, and/or instruct BT device 102 to select from the plurality of BT audio source devices 143 one or more recommended BT audio source devices for a BT audio connection for the user of device 102, e.g., as described below.

In some demonstrative aspects, controller 124 may be configured to identify and/or select the one or more recommended BT audio source devices from the plurality of BT audio source devices 143, for example, based on the metadata in the broadcast messages, e.g., as described below.

In some demonstrative aspects, controller 124 may be configured to cause, control, trigger, and/or instruct BT device 102 to select from the plurality of BT audio source devices 143 at least one recommended BT audio source device for a user of the BT device 102 for broadcast audio sharing with one or more other users in an audio sharing community of the user of the BT device 102, e.g., as described below.

In some demonstrative aspects, controller 124 may be configured to identify and/or select the recommended BT audio source device from the plurality of BT audio source devices 143, for example, based on the metadata in the broadcast messages, and based on audio consumption information corresponding to the audio sharing community of the user of the BT device 102, e.g., as described below.

In some demonstrative aspects, the audio consumption information corresponding to the audio sharing community of the user of the BT device 102 may include, for example, an indication of current broadcast audio data consumed, e.g., currently being consumed, by one or more users in the audio sharing community of the user of BT device 102, e.g., as described below.

In some demonstrative aspects, the audio consumption information corresponding to the audio sharing community of the user of the BT device 102 may include information to indicate which audio data is currently being consumed by one or more users in the audio sharing community of the user of BT device 102, e.g., as described below.

In some demonstrative aspects, the audio consumption information corresponding to the audio sharing community of the user of the BT device 102 may include information to indicate which audio data, e.g., from the audio data broadcasted by BT audio source devices 143, is currently being consumed by one or more users in the audio sharing community of the user of BT device 102, e.g., as described below.

In some demonstrative aspects, the audio consumption information corresponding to the audio sharing community of the user of the BT device 102 may include information to indicate which of BT audio source devices 143 is broadcasting audio data, which is also currently being consumed by one or more users in the audio sharing community of the user of BT device 102, e.g., as described below.

In some demonstrative aspects, the audio consumption information corresponding to the audio sharing community of the user of the BT device 102 may include information to indicate whether one or more users of the audio sharing community of the user of the BT device 102 are currently consuming audio data, which is similar to, identical to, audio data being broadcasted from one or more audio sources of the plurality of BT audio source devices 143, e.g., as described below.

In some demonstrative aspects, the audio consumption information corresponding to the audio sharing community of the user of the BT device 102 may include information to indicate whether one or more users of the audio sharing community of the user of the BT device 102 are currently consuming audio data from one or more audio sources of the plurality of BT audio source devices 143, e.g., as described below.

In some demonstrative aspects, the audio consumption information corresponding to the audio sharing community of the user of the BT device 102 may include information to indicate at least one particular BT audio source device 143, from which audio data is being consumed by one or more users of the audio sharing community of the user of the BT device 102, e.g., as described below.

In some demonstrative aspects, the audio consumption information corresponding to the audio sharing community of the user of the BT device 102 may include one or more audio data identifiers to identify one or more audio data streams being consumed by one or more users of the audio sharing community of the user of the BT device 102, e.g., as described below.

In one example, the audio consumption information corresponding to the audio sharing community of the user of the BT device 102 may include one or more Content Audio Signature Token (CAST) identifiers to identify one or more audio data streams being consumed by one or more users of the audio sharing community of the user of the BT device 102, e.g., as described below.

In some demonstrative aspects, the audio consumption information corresponding to the audio sharing community of the user of the BT device 102 may include one or more BT audio source identifiers to identify one or more BT audio source devices 143, which are broadcasting audio data which is being consumed by one or more users of the audio sharing community of the user of the BT device 102, e.g., as described below.

In one example, the audio consumption information corresponding to the audio sharing community of the user of the BT device 102 may include information to indicate that one or more users in the audio sharing community of the user of the BT device 102 are currently consuming audio data, which is broadcasted by a particular BT audio source device, e.g., BT audio source device 142.

In one example, the audio consumption information corresponding to the audio sharing community of the user of the BT device 102 may include information to indicate an identifier of a particular BT audio source device 143 from which one or more users in the audio sharing community of the user of the BT device 102 are currently consuming audio data.

In one example, the audio consumption information corresponding to the audio sharing community of the user of the BT device 102 may include information to indicate for a particular BT audio source device 143 a count of one or more users in the audio sharing community of the user of the BT device 102 that are currently consuming audio data broadcasted by a particular BT audio source device.

In other aspects, the audio consumption information corresponding to the audio sharing community of the user of the BT device 102 may include any other additional or alternative information corresponding to audio consumed by the audio sharing community of the user of the BT device 102.

In some demonstrative aspects, the audio consumption information corresponding to the audio sharing community of the user of the BT device 102 may be provided, for example, by server 199.

In some demonstrative aspects, controller 124 may be configured to cause, control, trigger, and/or instruct BT device 102 to select the recommended BT audio source device for audio sharing of the same broadcast audio content by the user of the BT device 102, and the one or more other users in the audio sharing community of the user of the BT device 102, e.g., as described below.

In some demonstrative aspects, controller 124 may be configured to cause, control, trigger, and/or instruct BT device 102 to select the recommended BT audio source device for audio sharing of multiple streams of the same broadcast audio content by the user of the BT device 102 and the one or more other users in the audio sharing community of the user of the BT device 102, e.g., as described below.

In some demonstrative aspects, the multiple streams of the same broadcast audio content may include, for example, at least a first stream of the broadcast audio content in a first language, and a second stream of the broadcast audio content in a second language.

In some demonstrative aspects, the multiple streams of the same broadcast audio content may include, for example, at least a first stream of a first version of the broadcast audio content, and a second stream of a second version, e.g., different from the first version, of the broadcast audio content.

In some demonstrative aspects, the one or more recommended BT audio source devices for the broadcast audio sharing may be recommended for a BT audio connection to be used by audio sink device 169, e.g., as described below.

In some demonstrative aspects, the one or more recommended BT audio source devices for the broadcast audio sharing may be recommended to a user of device 102, for example, to allow the user to manually select which of the recommended BT audio source devices to connect to, e.g., as described below.

In some demonstrative aspects, the one or more recommended BT audio source devices for the broadcast audio sharing may be utilized for automatic connection, for example, to automatically trigger connection of the audio sink device 169 to the one or more recommended BT audio source devices, e.g., as described below.

In some demonstrative aspects, controller 124 may be configured to cause, control, trigger, and/or instruct BT device 102 to determine the one or more recommended BT audio source devices for the broadcast audio sharing to include BT audio source devices for connection with audio sink device 169, e.g., as described below.

In some demonstrative aspects, controller 124 may be configured to cause, control, trigger, and/or instruct BT device 102 to determine the one or more recommended BT audio source devices for the broadcast audio sharing to include a plurality of recommended BT audio source devices, e.g., two or more of the BT audio source devices 143, for simultaneous connection with audio sink device 169, e.g., as described below.

In other aspects, controller 124 may be configured to cause, control, trigger, and/or instruct BT device 102 to determine the one or more recommended BT audio source devices for the broadcast audio sharing to include a single recommended BT audio source device for connection with audio sink device 169, e.g., as described below.

In some demonstrative aspects, controller 124 may be configured to cause, control, trigger, and/or instruct BT device 102 to automatically trigger establishment of the BT audio connection between the audio sink device 169 and the one or more recommended BT audio source devices for the broadcast audio sharing.

In some demonstrative aspects, controller 124 may be configured to cause, control, trigger, and/or instruct BT device 102 to output to the user of device 102 an indication of the one or more recommended BT audio source devices for the broadcast audio sharing, e.g., as described below.

For example, controller 124 may be configured to cause, control, trigger, and/or instruct output 193 to output to the user of device 102 an indication of the one or more recommended BT audio source devices for the broadcast audio sharing.

In one example, controller 124 may be configured to cause, control, trigger, and/or instruct BT device 102 to allow the user of device 102 to manually select one or more of the recommended BT audio source devices for the broadcast audio sharing.

In some demonstrative aspects, controller 124 may be configured to cause, control, trigger, and/or instruct BT device 102 to select the recommended BT audio source device for broadcast audio sharing with at least one particular user in the audio sharing community of the user of the BT device 102, for example, based on a determined match between audio data broadcasted by the recommended BT audio source device and broadcast audio data currently consumed by the particular user in the audio sharing community of the user of the BT device 102, e.g., as described below.

In some demonstrative aspects, controller 124 may be configured to cause, control, trigger, and/or instruct BT device 102 to select the recommended BT audio source device for broadcast audio sharing with at least one particular user in the audio sharing community of the user of the BT device 102, for example, based on a determination that the particular user is currently consuming broadcast audio data from the recommended BT audio source device, e.g., as described below.

In some demonstrative aspects, controller 124 may be configured to identify, for example, based on the audio consumption information, user count information to indicate a count of users in the audio sharing community of the user of the BT device 102, which are currently listening to audio content from a particular BT audio source device 143.

In some demonstrative aspects, controller 124 may be configured to the select recommended BT audio source device from the plurality of BT audio source devices 143, for example, based on the user count information.

In some demonstrative aspects, controller 124 may be configured to identify and/or select the recommended BT audio source device from the plurality of BT audio source devices 143, for example, based on the metadata in the broadcast messages, and based on a user profile corresponding to the user of the BT device 102, e.g., as described below.

In some demonstrative aspects, controller 124 may be configured to determine the audio sharing community of the user of the BT device 102, for example, based on the user profile corresponding to the user of the BT device 102, e.g., as described below.

In some demonstrative aspects, the user profile corresponding to the user of the BT device 102 may include personalized preference information corresponding to a preference of the user for selection of audio content, e.g., as described below.

In some demonstrative aspects, the user profile corresponding to the user of device 102 may be configured to include content information corresponding to audio content previously consumed by the user, e.g., as described below.

For example, controller 124 may be configured to cause, control, trigger, and/or instruct BT device 102 to determine, and/or dynamically update, the user profile for the user of device 102, for example, based on audio content previously consumed by the user of device 102, e.g., as described below.

For example, the audio sharing community of the user of the BT device 102 may be determined and/or dynamically updated, for example, based on the content information corresponding to the user of device 102.

In some demonstrative aspects, the user profile corresponding to the user of device 102 may be configured to include collaborative content information corresponding to at least one of audio content previously shared by the user with another user, audio content previously recommended by the user, and/or audio content previously recommended to the user, e.g., as described below.

For example, controller 124 may be configured to cause, control, trigger, and/or instruct BT device 102 to determine, and/or dynamically update, the user profile for the user of device 102, for example, based on audio content previously shared by the user of device 102 with another user, audio content previously recommended by the user of device 102, and/or audio content previously recommended to the user of device 102, e.g., as described below.

For example, the audio sharing community of the user of the BT device 102 may be determined and/or dynamically updated, for example, based on the collaborative content information corresponding to the user of device 102.

In some demonstrative aspects, the user profile corresponding to the user of device 102 may be configured to include social information corresponding to one or more other users socially associated with the user of device 102, e.g., as described below.

For example, controller 124 may be configured to cause, control, trigger, and/or instruct BT device 102 to determine, and/or dynamically update, the user profile for the user of device 102, for example, based on the social information corresponding to one or more other users socially associated with the user of device 102, e.g., as described below.

For example, the audio sharing community of the user of the BT device 102 may be determined and/or dynamically updated, for example, based on the social information corresponding to one or more other users socially associated with the user of device 102, e.g., as described below.

In some demonstrative aspects, the user profile may be configured to include user context information corresponding a current context of the user of device 102, e.g., as described below.

In some demonstrative aspects, the user context information may include at least one of environment information corresponding to an environment of the user, activity information corresponding to an activity of the user, social information corresponding to one or more other users in proximity to the user, and/or user requirement information corresponding to one or more requirements of the user, e.g., as described below. In other aspects, the user context information may include any other additional or alternative type of context information.

For example, controller 124 may be configured to cause, control, trigger, and/or instruct BT device 102 to determine, and/or dynamically update, the user profile for the user of device 102, for example, based on an environment of the user of device 102, activity information corresponding to an activity of the user of device 102, social information corresponding to one or more other users in proximity to the user of device 102, user requirement information corresponding to one or more requirements of the user of device 102, and/or any other additional or alternative type of context information.

In some demonstrative aspects, controller 124 may be configured to cause, control, trigger, and/or instruct BT device 102 to provide to the user of the BT device 102 an audio sharing interface 129 (“BT Audio Share Session Interface”) to interface between the user of the BT device 102 and one or more other users during a broadcast audio sharing session, e.g., as described below.

In some demonstrative aspects, the audio sharing interface 129 may be implemented in the form of a Graphic User Interface (GUI), e.g., as described below. In other aspects, the audio sharing interface 129 may be implemented by any other interface type and/or functionality.

In some demonstrative aspects, the audio sharing interface 129 may be configured to provide a technical solution to support collaborative listening and/or enhanced social experience between the user of BT device 102 and the other users during the broadcast audio sharing session.

In some demonstrative aspects, the audio sharing interface 129 may be configured to communicate one or more messages between the user of the BT device 102 and the one or more other users during the broadcast audio sharing session, e.g., as described below.

In some demonstrative aspects, the audio sharing interface 129 may include a graphic messaging interface, which may be configured, for example, to display one or more messages communicated between the user of the BT device 102 and the one or more other users during the broadcast audio sharing session, e.g., as described below.

In some demonstrative aspects, the audio sharing interface 129 may be configured to input an invitation request from the user of the BT device 102 to indicate that a user is to be invited to the audio sharing session, e.g., as described below.

In some demonstrative aspects, the audio sharing interface 129 may be configured to trigger, for example, based on the invitation request, an invitation message to be sent to the user to be invited to the audio sharing session, e.g., as described below.

In some demonstrative aspects, server 199 may be configured to implement a BT audio sharing mechanism, which may be configured to support adaptation, e.g., online adaptation and/or real-time adaptation, of content to be provided by a BT audio source device 143 to a group of users (“audio sharing group”) sharing content broadcasted by the BT audio source device 143, e.g., as described below.

In some demonstrative aspects, the BT audio sharing mechanism may be configured to provide a technical solution to support leveraging of multiple stream broadcast capabilities and/or leveraging of online feedback from users, e.g., as described below.

In some demonstrative aspects, controller 174 may be configured to cause, control, trigger, and/or instruct server 199 to identify an audio sharing group including a plurality of users of BT devices, e.g., including deice 102, which may be, for example, concurrently sharing audio content broadcasted by a BT audio source device 143, e.g., as described below.

For example, controller 174 may be configured to identify the audio sharing group, for example, based on information received from the BT audio source device 143, and/or based on information received from the BT devices, e.g., from device 102.

In some demonstrative aspects, controller 174 may be configured to cause, control, trigger, and/or instruct server 199 to determine group-adapted audio content for the audio sharing group, for example, based on a plurality of user profiles corresponding to the plurality of users in the audio sharing group, e.g., as escribed below.

In some demonstrative aspects, a user profile corresponding to a user may include personalized preference information corresponding to a preference of the user for selection of audio content, e.g., as described above.

For example, the user profile corresponding to the user of BT device 102 may include personalized preference information corresponding to a preference of the user of BT device 102 for selection of audio content, e.g., as described above.

In some demonstrative aspects, controller 174 may be configured to cause, control, trigger, and/or instruct server 199 to send a request to the BT audio source device 143 to broadcast the group-adapted audio content for the audio sharing group, e.g., as described below.

In some demonstrative aspects, controller 174 may be configured to cause, control, trigger, and/or instruct server 199 to determine a language of the group-adapted audio content for the audio sharing group, for example, based on the plurality of user profiles corresponding to the plurality of users in the audio sharing group, e.g., as escribed below.

In some demonstrative aspects, controller 174 may be configured to cause, control, trigger, and/or instruct server 199 to determine a version of the group-adapted audio content for the audio sharing group, for example, based on the plurality of user profiles corresponding to the plurality of users in the audio sharing group, e.g., as escribed below.

In some demonstrative aspects, controller 174 may be configured to cause, control, trigger, and/or instruct server 199 to determine recommended audio content for the audio sharing group, for example, based on the plurality of user profiles corresponding to the plurality of users in the audio sharing group.

In some demonstrative aspects, controller 174 may be configured to cause, control, trigger, and/or instruct server 199 to send to the plurality of users in the audio sharing group a recommendation to indicate the recommended audio content.

In some demonstrative aspects, controller 174 may be configured to cause, control, trigger, and/or instruct server 199 to determine a recommended BT audio source device 143 for the audio sharing group, for example, based on the plurality of user profiles corresponding to the plurality of users in the audio sharing group.

In some demonstrative aspects, controller 174 may be configured to cause, control, trigger, and/or instruct server 199 to send to the plurality of users in the audio sharing group a recommendation to indicate the recommended BT audio source device 143, e.g., as described below.

In some demonstrative aspects, controller 174 may be configured to cause, control, trigger, and/or instruct server 199 to establish a broadcast audio sharing session for the plurality of users in the audio sharing group, e.g., as described below.

In some demonstrative aspects, controller 174 may be configured to cause, control, trigger, and/or instruct server 199 to communicate one or more messages between the plurality of users in the audio sharing group during the broadcast audio sharing session, e.g., as described below.

For example, controller 174 may be configured to cause, control, trigger, and/or instruct server 199 to communicate the messages between the plurality of users in the audio sharing group, for example, via the audio sharing interface 129 of the BT devices.

In some demonstrative aspects, controller 174 may be configured to cause, control, trigger, and/or instruct server 199 to communicate an invitation request from a first user in the audio sharing group to a second user to be invited to the audio sharing session. For example, server 199 may receive the invitation request from the audio sharing interface 129 of BT device 102, e.g., as described above.

In some demonstrative aspects, controller 174 may be configured to cause, control, trigger, and/or instruct server 199 to identify a first audio sharing group including a first plurality of users of BT devices, e.g., including the user of the BT device 102 and one or more uses of one or more first other BT devices. For example, the first plurality of users of the first audio sharing group may concurrently share at a first time period audio content broadcasted by a particular BT audio source device 143, e.g., the BT audio source device 140.

In some demonstrative aspects, controller 174 may be configured to cause, control, trigger, and/or instruct server 199 to determine first group-adapted audio content for the first audio sharing group, for example, based on user profiles corresponding to the first plurality of users.

In some demonstrative aspects, controller 174 may be configured to cause, control, trigger, and/or instruct server 199 to send a first request to the particular BT audio source device, e.g., the BT audio source device 140, to broadcast the first group-adapted audio content for the first audio sharing group.

In some demonstrative aspects, controller 174 may be configured to cause, control, trigger, and/or instruct server 199 to identify a second audio sharing group including a second plurality of users of BT devices, e.g., not including the user of BT device 102. For example, the second plurality of users of the second audio sharing group may concurrently share at a second time period audio content broadcasted by the particular BT audio source device 143, e.g., the BT audio source device 140. For example, the second time period may be after the first time period.

In some demonstrative aspects, controller 174 may be configured to cause, control, trigger, and/or instruct server 199 to determine second group-adapted audio content for the second audio sharing group, for example, based on user profiles corresponding to the second plurality of users.

In some demonstrative aspects, controller 174 may be configured to cause, control, trigger, and/or instruct server 199 to send a second request to the particular BT audio source device, e.g., the BT audio source device 140, to broadcast the second group-adapted audio content for the second audio sharing group.

In some demonstrative aspects, the second group-adapted audio content for the second audio sharing group may be different from the first group-adapted audio content for the second audio sharing group.

In some demonstrative aspects, a language of the second group-adapted audio content for the second audio sharing group may be different from a language the first group-adapted audio content for the second audio sharing group.

In one example, both the first group-adapted audio content for the first audio sharing group and the second group-adapted audio content for the second audio sharing group may include the same audio content in different languages.

In some demonstrative aspects, a version of the second group-adapted audio content for the second audio sharing group may be different from a version the first group-adapted audio content for the second audio sharing group.

In one example, both the first group-adapted audio content for the first audio sharing group and the second group-adapted audio content for the second audio sharing group may include the same audio content in different versions.

In some demonstrative aspects, controller 174 may be configured to cause, control, trigger, and/or instruct server 199 to identify a first audio sharing group including a first plurality of users of BT devices, e.g., including the user of the BT device 102 and one or more uses of one or more first other BT devices. For example, the first plurality of users of the first audio sharing group may concurrently share audio content broadcasted by a first BT audio source device 143, e.g., BT audio source device 142.

In some demonstrative aspects, controller 174 may be configured to cause, control, trigger, and/or instruct server 199 to determine first group-adapted audio content for the first audio sharing group, for example, based on user profiles corresponding to the first plurality of users.

In some demonstrative aspects, controller 174 may be configured to cause, control, trigger, and/or instruct server 199 to send a first request to the first BT audio source device, e.g., BT audio source device 142, to broadcast the first group-adapted audio content for the first audio sharing group.

In some demonstrative aspects, controller 174 may be configured to cause, control, trigger, and/or instruct server 199 to identify a second audio sharing group including a second plurality of users of BT devices, e.g., not including the user of BT device 102. For example, the second plurality of users of the second audio sharing group may concurrently share audio content broadcasted by a second BT audio source device 143, e.g., BT audio source device 144.

In some demonstrative aspects, controller 174 may be configured to cause, control, trigger, and/or instruct server 199 to determine second group-adapted audio content for the second audio sharing group, for example, based on user profiles corresponding to the second plurality of users.

In some demonstrative aspects, controller 174 may be configured to cause, control, trigger, and/or instruct server 199 to send a second request to the second BT audio source device, e.g., BT audio source device 144, to broadcast the second group-adapted audio content for the second audio sharing group.

In some demonstrative aspects, the second group-adapted audio content for the second audio sharing group may be different from the first group-adapted audio content for the second audio sharing group.

In some demonstrative aspects, a language of the second group-adapted audio content for the second audio sharing group may be different from a language the first group-adapted audio content for the second audio sharing group.

In one example, both the first group-adapted audio content for the first audio sharing group and the second group-adapted audio content for the second audio sharing group may include the same audio content in different languages.

In some demonstrative aspects, a version of the second group-adapted audio content for the second audio sharing group may be different from a version the first group-adapted audio content for the second audio sharing group.

In one example, both the first group-adapted audio content for the first audio sharing group and the second group-adapted audio content for the second audio sharing group may include the same audio content in different versions.

In some demonstrative aspects, BT device 102 and/or server 199 may be configured to implement an audio-source selection mechanism, which may be configured to score and/or rank audio share content sources, e.g., one or more of the BT audio sources 143, e.g., as described below.

In some demonstrative aspects, the audio-source selection mechanism may be configured to score and/or rank audio share content sources, e.g., one or more of the BT audio source devices 143, according to one or more scoring and/or ranking criteria, which may be configured to identify and/or prioritize one or more BT audio source devices 143, which may be most relevant for the user of device 102 to connect to, e.g., as described below.

In some demonstrative aspects, the audio-source selection mechanism may be configured as a personalized, community based, and/or context-aware audio share content selection mechanism, which may be aware of some or all available BT audio share content sources 143, and may utilize a user audio share profile of the user of device 102 to select one or more available BT audio share content source devices 143, e.g., as described below.

In some demonstrative aspects, the user audio profile of the user of device 102 may be determined and/or dynamically updated based on personal information corresponding to the user of device 102, e.g., as described below.

In some demonstrative aspects, the user audio profile of the user of device 102 may be determined and/or dynamically updated based on social data of the user of device 102, e.g., as described below.

In some demonstrative aspects, the user audio profile of the user of device 102 may be determined and/or dynamically updated based on audio share community data of the audio share community of the user of device 102, e.g., as described below.

In some demonstrative aspects, the user audio profile of the user of device 102 may be determined and/or dynamically updated based on audio share connection history of the user of device 102, e.g., as described below.

In some demonstrative aspects, the user audio profile of the user of device 102 may be determined and/or dynamically updated based on current, e.g., dynamic, contextual data corresponding to the user of device 102, e.g., as described below.

In some demonstrative aspects, the contextual data corresponding to the user of device 102 may include information relating to an environmental context, for example, information to indicate a location of the user, e.g., an airport lounge, an open office space, a noise level in the environment, and/or any other additional or alternative information relating to the environment of the user.

In some demonstrative aspects, the contextual data corresponding to the user of device 102 may include information relating to an activity of the user, e.g., the user's current listening activity, e.g., an indication that the user is currently listening to music, an indication that the user is on a phone call, and/or any other information relating to a listening activity of the user.

In some demonstrative aspects, the contextual data corresponding to the user of device 102 may include information relating to the user's general activity, for example, whether the user is sitting, walking, working on a computer, information relating to an activity of people in close proximity to the user, and/or any other information.

In some demonstrative aspects, the contextual data corresponding to the user of device 102 may include information relating to the user's audio share community, e.g., members of the user's community which are at the vicinity of the user, and/or any other social-related information.

In some demonstrative aspects, the contextual data corresponding to the user of device 102 may include information relating to the user's needs.

In some demonstrative aspects, the contextual data corresponding to the user of device 102 may include any other additional or alternative contextual information.

In some demonstrative aspects, controller 124 may be configured to cause, control, trigger, and/or instruct BT device 102 to determine one or more recommended BT audio source devices, which are to be recommended for the user of device 102, for example, according to a selection (filtering) mechanism, which may utilize recommendation and/or selection techniques, which may be, for example, based on collaborative/or and content-based filtering.

For example, these recommendation and/or selection techniques may be configured and/or adjusted to address one or more needs, e.g., unique needs, of audio content sharing activity.

For example, these recommendation and/or selection techniques may be configured and/or adjusted to target an enhanced, e.g., ultimate, user experience that leverages some or all of the offerings, e.g., an ability to simultaneously connect to multiple streams by one, and/or simultaneous sharing of the same content by many.

In some demonstrative aspects, controller 124 may be configured to cause, control, trigger, and/or instruct BT device 102 to identify data corresponding to a BT audio source device of BT audio source devices 143, e.g., BT audio source device 140, for example, based on the metadata in the broadcast message from the BT audio source device 140, e.g., as described below.

In some demonstrative aspects, controller 124 may be configured to cause, control, trigger, and/or instruct BT device 102 to retrieve from server 199 at least part of the data corresponding to the BT audio source device 140, for example, based on the metadata in the broadcast message from the BT audio source device 140, e.g., as described below.

In some demonstrative aspects, the data corresponding to the BT audio source device 140 may include, for example, data corresponding to users currently connected to the BT audio source device 140, e.g., as described below.

In some demonstrative aspects, the data corresponding to the BT audio source device 140 may include, for example, user profile data corresponding to the users currently connected to the BT audio source device 140.

In some demonstrative aspects, the data corresponding to the BT audio source device 140 may include, for example, user profile data corresponding to the users previously connected to the BT audio source device 140.

In some demonstrative aspects, the data corresponding to the BT audio source device 140 may include and/or other additional or alternative data.

In some demonstrative aspects, controller 124 may be configured to determine one or more recommended BT audio source devices, which are to be recommended for the user of device 102, for example, according to a selection (filtering) mechanism, which may utilize on-line information corresponding to the BT audio sources 143, e.g., as described below.

In some demonstrative aspects, controller 124 may be configured to utilize the on-line information corresponding to the BT audio sources 143, for example, to determine an on-line score, e.g., an online popularity score, for one or more of the BT audio sources 143, e.g., as described below.

In some demonstrative aspects, controller 124 may be configured to determine the one or more recommended BT audio source devices, which are to be recommended for the user of device 102, for example, based on the on-line score, e.g., as described below.

In some demonstrative aspects, the popularity of audio share content of a BT audio source device, e.g., BT audio source device 140, may be monitored, e.g., on-line monitored.

In some demonstrative aspects, metadata may be added to an audio share content source, for example, to support scoring of the audio share source via one or more source selection metrics, e.g., as described below.

In some demonstrative aspects, the source selection metrics may include one or more global metrics, for example, a number of people who are sharing the content of a BT audio source and are in the audio share community of a particular user.

In some demonstrative aspects, the source selection metrics may include, for example, a duration of connection time, a like/dislike indication from a user with respect to the audio content, a user feedback score, and the like.

In some demonstrative aspects, the popularity score may be utilized to benchmark audio content. In one example, the popularity score may be provided by audio/media BT share content advisors, for example, to guide consumers to make educated audio share channel choices.

In some demonstrative aspects, the popularity score may be utilized to automatically prioritize the selection of the BT audio share channel offered to a user at a public venue.

In some demonstrative aspects, the satisfaction of the user of the audio share content may be monitored, for example, by server 199. For example, information on the satisfaction of the user may be utilized to leverage one or more Human-Computer Interaction (HCI) metrics, which may, for example, provide an indication on attention and/or interest of the user in association with the audio share content that he/she is currently listening into.

In some demonstrative aspects, on-line metrics may be leveraged, e.g., by server 199, for example, to adapt the audio share content, e.g., with the goal to raise the interest and/or satisfaction, of an individual and/or an audio share community experience.

In some demonstrative aspects, the on-line metrics may be utilized for development of enhanced, e.g., more personalized, recommendation and/or selection algorithms for BT audio share content.

In some demonstrative aspects, controller 124 may be configured to identify data corresponding to BT audio source device 140, for example, based on the metadata in the broadcast message from the BT audio source device 140, e.g., as described below.

In some demonstrative aspects, controller 124 may be configured to identify in the broadcast message from a BT audio source device, e.g., BT audio source device 140, a Content Audio Signature Token (CAST). The CAST may be configured as a unique signature of content corresponding to the BT audio source. The CAST may be sent, for example, as a metadata field in the advertising data from the various broadcast sources.

In some demonstrative aspects, controller 124 may be configured to process the CAST and expand it into various criteria information, which may be retrieved, for example, from a cloud-based system, e.g., from server 199. For example, the expansion of the CAST may provide various content criteria items, e.g., as described below.

In some demonstrative aspects, controller 124 may be configured to identify based on the metadata in the broadcast message from a BT audio source device, e.g., BT audio source device 140, one or more content preference counters, for example, a number of users choosing the content broadcast by the BT audio source device, a number of current listeners, or the like.

In some demonstrative aspects, controller 124 may be configured to identify based on the metadata in the broadcast message from a BT audio source device, e.g., BT audio source device 140, content time preference information, for example, an amount of time listeners stay on the content from the BT audio source device.

In some demonstrative aspects, controller 124 may be configured to identify based on the metadata in the broadcast message from a BT audio source device, e.g., BT audio source device 140, score/rank information to indicate a score and/or rank corresponding to the audio content broadcasted by the BT audio source device. For example, score/rank information may include information to indicate if the content gets a high average favorite ranking, e.g. 5 starts, 4 stars, or the like.

In some demonstrative aspects, controller 124 may be configured to identify based on the metadata in the broadcast message from a BT audio source device, e.g., BT audio source device 140, category information corresponding to a category of the of content broadcasted by the BT audio source device. For example, the category information may include an indication of a sport category, a science category, a politics category, a news category, a music genre 1, a music genre 2, or the like.

In some demonstrative aspects, controller 124 may be configured to identify based on the metadata in the broadcast message from a BT audio source device, e.g., BT audio source device 140 any other additional or alternative information corresponding to the BT audio source device 140.

In some demonstrative aspects, controller 124 may be configured to retrieve from server 199 at least some of the information corresponding to the BT audio source device 140, for example, based on the metadata in the broadcast message from BT audio source device, e.g., based on the CAST in the broadcast message from BT audio source device 140.

In some demonstrative aspects, controller 124 may be configured to determine at least some of the information corresponding to the BT audio source device 140, for example, based on the metadata in the broadcast message from the BT audio source device 140, e.g., based on one or more metadata fields in the broadcast message from the BT audio source device 140.

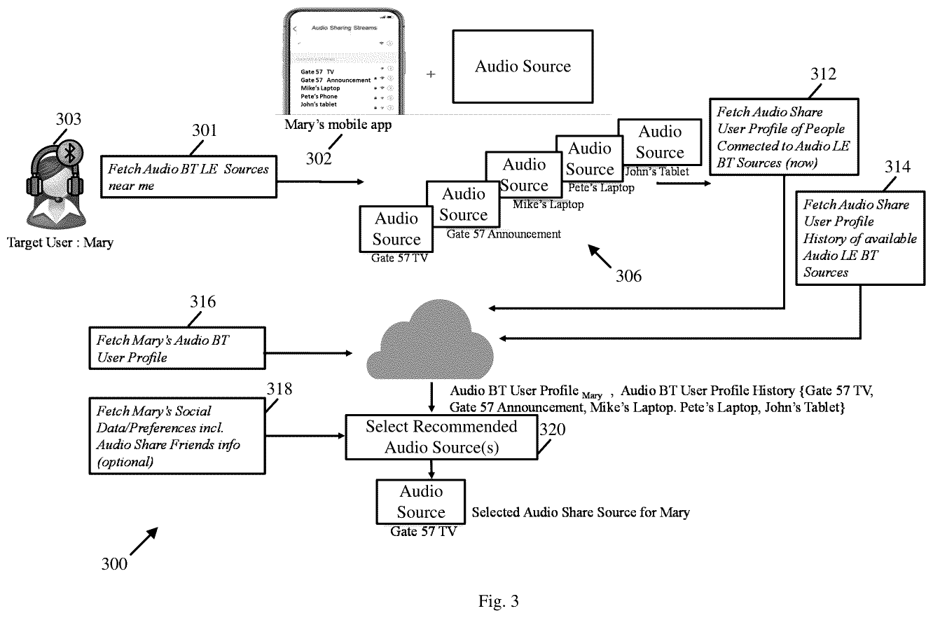

Reference is made to FIG. 3, which schematically illustrates a BT audio source selection scheme 300, in accordance with some demonstrative aspects. For example, controller 124 (FIG. 1) may be configured to implement an application 302 configured to perform one or more operations and/or functionalities of the BT audio source selection scheme 300, for example, to select one or more recommended BT audio source devices from the plurality of BT audio source devices 143 (FIG. 1) to be recommended for a user 303 (Mary) of device 102 (FIG. 1).

In some demonstrative aspects, as shown in FIG. 3, a plurality of available BT audio sources 306 may be identified (301). For example, a BT device, e.g., BT device 102 (FIG. 1), may be configured to identify a plurality of BT audio sources, e.g., the plurality of BT audio sources 143 (FIG. 1) in a vicinity of the BT device.

In one example, as shown in FIG. 3, the user 303 of the BT device may be at a location, for example, an airport location, or any other location.

For example, the BT device, e.g., BT device 102 (FIG. 1), may detect a plurality of broadcast messages from the plurality of BT audio sources 306.

For example, as shown in FIG. 3, the BT device may detect a first broadcast message from a first BT audio source, e.g., a television (TV) device (“Gate 57 TV”), which may advertise a TV broadcast from the TV device.

For example, as shown in FIG. 3, the BT device may detect a second broadcast message from a second BT audio source, e.g., an announcement device (“Gate 57 Announcement”), which may advertise gate announcements from the announcement device.

For example, as shown in FIG. 3, the BT device may detect a third broadcast message from a third BT audio source, e.g., a mobile device, for example, a BT device of a first other user (“Mike's Laptop”), which may advertise a BT audio stream broadcasted by the third BT audio source.

For example, as shown in FIG. 3, the BT device may detect a fourth broadcast message from a fourth BT audio source, e.g., a mobile device, for example, a BT device of a second other user (“Pete's Laptop”), which may advertise a BT audio stream broadcasted by the fourth BT audio source.

For example, as shown in FIG. 3, the BT device may detect a fifth broadcast message from a fifth BT audio source, e.g., a mobile device, for example, a BT device of a third other user (“John's Tablet”), which may advertise a BT audio stream broadcasted by the fifth BT audio source.

For example, the BT device may detect some or all of the BT devices and/or any other additional or alternative BT devices.

In some demonstrative aspects, as shown in FIG. 3, the application 302 may be configured to identify (312) one or more audio share user profiles of one or more other users connected to the BT audio sources 306. For example, application 302 may retrieve the audio share user profiles of one or more other users connected to the BT audio sources 306 from a server, e.g., server 199 (FIG. 1), for example, based on metadata in the messages broadcasted by the BT audio sources 306, e.g., as described above.

In some demonstrative aspects, as shown in FIG. 3, the application 302 may be configured to identify (314) one or more audio share user profile histories corresponding to the BT audio sources 306. For example, application 302 may retrieve the audio share user profile histories from a server, e.g., server 199 (FIG. 1), for example, based on metadata in the messages broadcasted by the BT audio sources 306, e.g., as described above.

In some demonstrative aspects, as shown in FIG. 3, the application 302 may be configured to identify (316) an audio BT user profile corresponding to the user 303. For example, application 302 may retrieve the audio BT user profile corresponding to the user 303 from a local memory of the BT device and/or from a server, e.g., server 199 (FIG. 1).

In some demonstrative aspects, as shown in FIG. 3, the application 302 may be configured to identify (318) social information corresponding to the user 303. For example, application 302 may retrieve the social information corresponding to the user 303 from a local memory of the BT device and/or from a server, e.g., server 199 (FIG. 1). In one example, social information corresponding to the user 303 may be included as part of the audio BT user profile corresponding to the user 303.

In some demonstrative aspects, as shown in FIG. 3, the application 302 may be configured to determine (320) one or more recommended BT audio source devices from the plurality of BT audio source devices 306, for example, based on the audio BT user profile corresponding to the user 303, the audio share user profiles of one or more other users connected to the BT audio sources 306, the audio share user profile histories corresponding to the BT audio sources 306, and/or the social information corresponding to the user 303.

In some demonstrative aspects, the application 302 may be configured to determine the one or more recommended BT audio source devices to include at least one recommended BT audio source device for the user 303 for broadcast audio sharing with one or more other users in an audio sharing community of the user 303.

In some demonstrative aspects, the application 302 may be configured to determine the recommended BT audio source device for the user 303 for broadcast audio sharing, for example, based on audio consumption information corresponding to the audio sharing community of user 303.

In some demonstrative aspects, the audio consumption information may include an indication of current broadcast audio data currently consumed by the audio sharing community of user 303, e.g., as described above.

For example, as shown in FIG. 3, the application 302 may be configured to determine that the first BT audio source (“Gate 57 TV”) is to be recommended to the user 303.

In some demonstrative aspects, application 302 may be configured to determine a score (“audio share source match sore”) corresponding to a BT audio source 306.

For example, application 302 may be configured to determine the audio share source match sore for a particular BT audio source device of BT audio source devices 306, for example, based on profiles of users who are connected to the particular BT audio source device and the audio share profile of the user 303. For example, the audio share source match score for the particular BT audio source device may be based on a similarity between a history of connections of the user 303, e.g., according to the audio share profile of the user 303, and connection history of other users who are currently connected to the particular BT audio source.

For example, the audio share source match score may be configured to indicate at least one best audio source device of BT audio source devices 306 for the user 303 to get connected to.

In some demonstrative aspects, the application 302 may be configured to determine one or more recommended BT audio source devices to be recommended to the user 303, for example, based on the user profile histories of users of the BT audio source devices 306, and the BT audio share profile of the user 303.

In some demonstrative aspects, the application 302 may be configured to determine whether a particular BT audio source device is to be recommended to the user 303, for example, based on a correlation between the user profile histories of users who have consumed (shared) content of the particular BT audio source device in the past, and content that the user 303 has consumed (shared) in the past, e.g., according to the BT audio share profile of the user 303.

In some demonstrative aspects, the application 302 may be configured to utilize a contextual-based filtering mechanism for the selection of one or more recommended BT audio source devices from the plurality of BT audio source devices 306, for example, based on user context information corresponding to the user 303, e.g., as described below.

In some demonstrative aspects, the application 302 may be configured to take into consideration actual on-line data about the user 303, for example, while making recommendations for the audio share sources 306. For example, the actual on-line data about the user 303 may be taken into account in order to address the needs of user 303, for example, via offering connections to multiple streams, and/or while taking into consideration other relevant environmental parameters.

In some demonstrative aspects, the user context information corresponding to the user 303 may include information corresponding to a user environmental context, e.g., including a noise level. For example, the user context information corresponding to the user 303 may indicate whether the user 303 is at a public venue or private/personal space, and/or the noise level at the location of the user 303, and/or any other information.

In some demonstrative aspects, the user context information corresponding to the user 303 may include information corresponding to a user listening activity. For example, the user context information corresponding to the user 303 may indicate whether the user 303 is listening to music, talking on the phone, watching a movie, watching TV, listening to a tour guide, or performing any other listening activity, and/or any other information.

In some demonstrative aspects, the user context information corresponding to the user 303 may include information corresponding to a user general activity, e.g., including activities of other people in the vicinity of the user 303. For example, the user context information corresponding to the user 303 may indicate whether there are other people in vicinity of the user 303, are the other people performing a similar or different activity than the user 303, are the other people quiet or noisy, and/or any other information.

In some demonstrative aspects, the user context information corresponding to the user 303 may include information corresponding to user audio share community members, e.g., in the vicinity of the user 303. For example, the user context information corresponding to the user 303 may indicate whether there are other people around the user 303 who are likely to be sharing an audio BT experience with the user 303, and/or any other information.

In some demonstrative aspects, the user context information corresponding to the user 303 may include information, which may support prioritizing audio share sources, for example, based on audio share content selection of people in an audio share community and/or in a vicinity of the user 303.

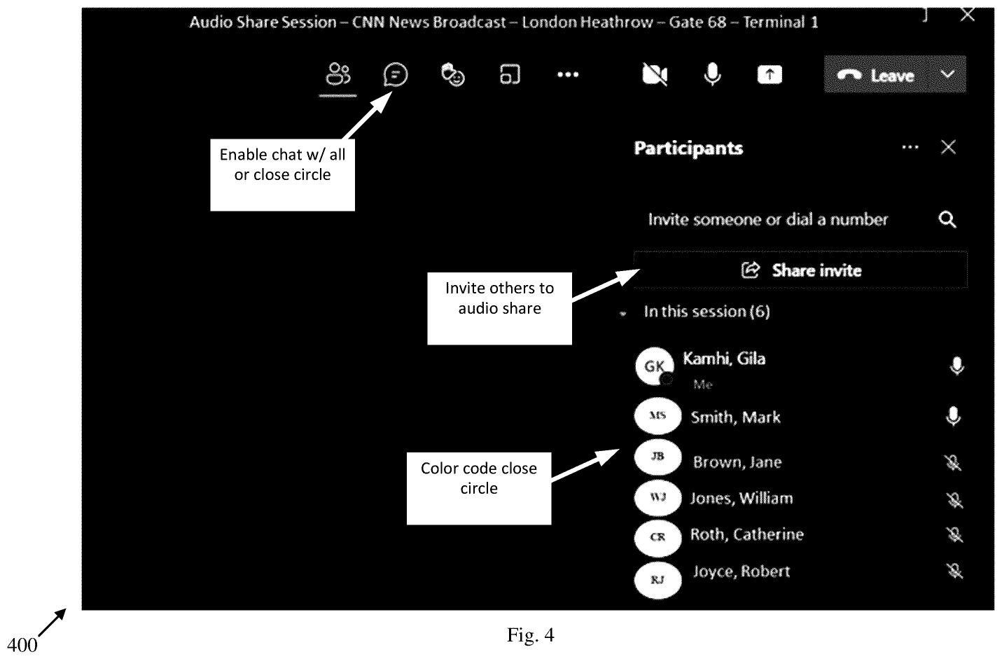

Reference is made to FIG. 4, which schematically illustrates a BT audio sharing interface 400, in accordance with some demonstrative aspects.

For example, audio sharing interface 129 (FIG. 1) may be configured to implement one or more elements, operations, and/or functionalities of, BT audio sharing interface 400, for example, to interface between a user of BT device 102 (FIG. 1), and one or more other users of other BT devices, for example, during a broadcast audio sharing session.

In some demonstrative aspects, as shown in FIG. 4, BT audio sharing interface 400 may be implemented in the form of a GUI, which may include graphical elements configured to support collaborative listening and/or enhanced social experience between the user of a BT device, e.g., the user of BT device 102 (FIG. 1), and the other users, for example, during a broadcast audio sharing session.

In some demonstrative aspects, as shown in FIG. 4, BT audio sharing interface 400 may be configured to graphically provide to the user an indication of the participants the broadcast audio sharing session.

For example, BT audio sharing interface 400 may be configured to provide to the user an indication of participants in a close circle of the user. In one example, BT audio sharing interface 400 may be configured to utilize color coding, and/or any other mechanism, to indicate the participants in the close circle of the user.

In some demonstrative aspects, Identifiers (ID) of the participants may be anonymized.

In some demonstrative aspects, BT audio sharing interface 400 may provide IDs of some participants, e.g., participant(s) who allow themselves to be identified, e.g., in order to achieve an “enhanced social” experience.

In some demonstrative aspects, as shown in FIG. 4, BT audio sharing interface 400 may be configured to include a “chat” button, which may allow the user of BT audio sharing interface 400 to communicate one or more messages some or all of the other users participating in the broadcast audio sharing session.

For example, BT audio sharing interface 400 may be configured to allow a chat of participants in a close circle of the user, or between all participants.

For example, BT audio sharing interface 400 may be configured to allow the participants of the broadcast audio sharing session to provide feedback, for example, during the session, e.g., in real time.

In some demonstrative aspects, as shown in FIG. 4, BT audio sharing interface 400 may include a “share invite” button, which may be configured to allow the user to invite one or more other users to the audio sharing session.

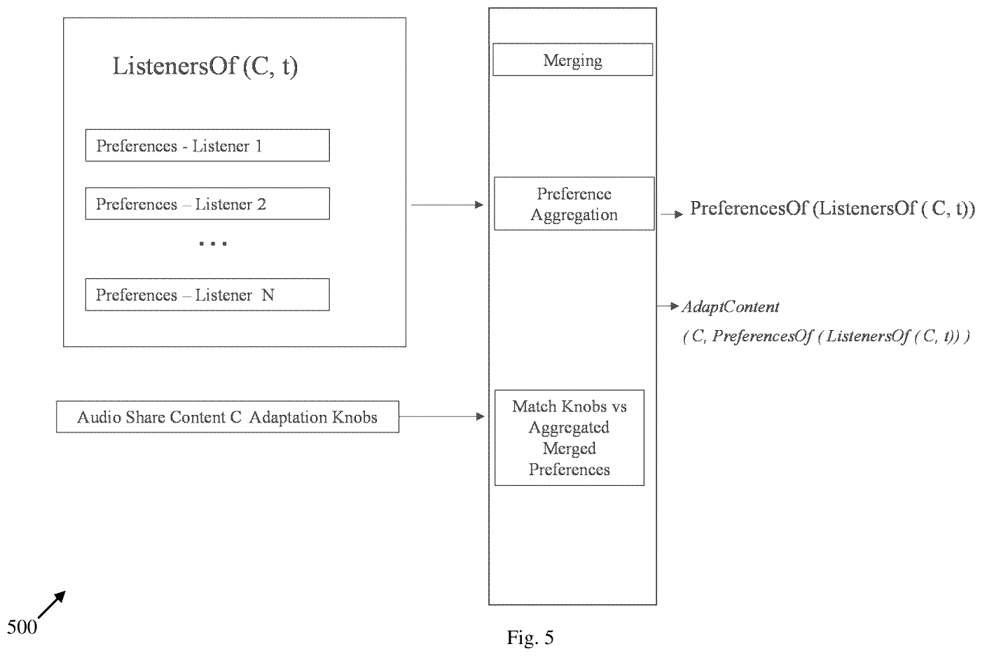

Reference is made to FIG. 5, which schematically illustrates a BT audio sharing mechanism 500, in accordance with some demonstrative aspects.

In some demonstrative aspects, controller 174 (FIG. 1) may be configured to cause, control, trigger, and/or instruct server 199 (FIG. 1) to perform one or more operations and/or functionalities according to BT audio sharing mechanism 500, for example, to determine a group recommendation to be provided to a group of users, e.g., including N users, and/or to adapt the content, e.g., based on group preferences of the group of users.

For example, as shown in FIG. 5, BT audio sharing mechanism 500 may be configured to determine a group recommendation to be provided to a group of users, e.g., including the user of the BT device 102 (FIG. 1), which are listening to a common audio content, denoted C, at a time, denoted t, and/or to adapt the content C, e.g., based on group preferences of the group of users.

In one example, the time t may be a current time. In another example, the time t may relate to a time in the past.

In some demonstrative aspects, as shown in FIG. 5, BT audio sharing mechanism 500 may include determining a preference aggregation of the group of users listening to the content C at the time t, for example, based on preferences of the users in the group of N users. For example, the preferences of the users in the group of N users may be identified based on the user profiles of the group of N users.

In some demonstrative aspects, as shown in FIG. 5, BT audio sharing mechanism 500 may include determining one or more possible content adaptations (adaptation knobs) available for providing one or more adapted versions of the content C.

In some demonstrative aspects, as shown in FIG. 5, BT audio sharing mechanism 500 may include determining a group recommendation to be provided to the group of N users, and/or to adapt the content C, for example, based on the preference aggregation and the adaptation knobs.

In some demonstrative aspects, controller 174 (FIG. 1) may be configured to cause, control, trigger, and/or instruct server 199 (FIG. 1) to determine the group recommendation for the group of users and/or to adapt the content C for the group of users according to the BT audio sharing mechanism 500, for example, based on one or more operations of the following algorithm:

For all users listening to content C at time t:
1. ListenersOf (C, t) /* Extract all the users in his vicinity that are also listening to content C at time t */
2. PreferencesOf (ListenersOf (C, t))<={Language, DomainOfInterest, version . . . } /* Extract Merged list of preferences */
3. AdaptContent (C, PreferencesOf (ListenersOf (C, t))) /* Adapt content C taking into consideration preferences of all current listeners—e.g., Broadcast in Spanish if all users are native Spanish speakers */
4. RecommendAudioShare (ListenersOf (C, t)) /* Recommend new content that all the new group that we have created is interested in listening to */

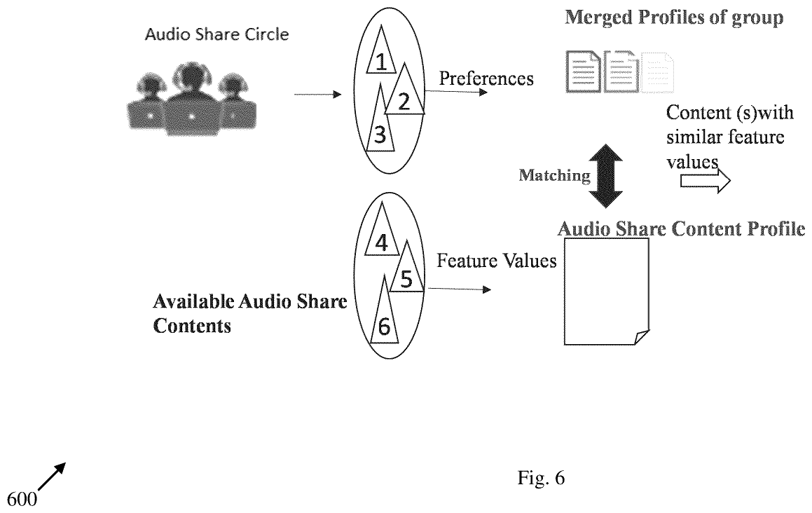

Reference is made to FIG. 6, which schematically illustrates a BT audio sharing group recommendation mechanism 600, in accordance with some demonstrative aspects.

In some demonstrative aspects, controller 174 (FIG. 1) may be configured to cause, control, trigger, and/or instruct server 199 (FIG. 1) to perform one or more operations and/or functionalities according to BT audio sharing group recommendation mechanism 600, for example, to determine a group recommendation to be provided to a group of users.

In some demonstrative aspects, as shown in FIG. 6, BT audio sharing group recommendation mechanism 600 may be configured to determine a group recommendation to be provided to a group of users, e.g., including the user of the BT device 102 (FIG. 1), e.g., based on group preferences of the group of users.

In some demonstrative aspects, as shown in FIG. 6, BT audio sharing group recommendation mechanism 600 may include determining a merged profile for the group of users, for example, based on preferences of the users in the group. For example, the preferences of the users in the group may be identified based on the user profiles of the users in the group.

In some demonstrative aspects, as shown in FIG. 6, BT audio sharing group recommendation mechanism 600 may include determining available audio share contents, which may be available for sharing with the group of users.

In some demonstrative aspects, as shown in FIG. 6, BT audio sharing group recommendation mechanism 600 may include determining a group recommendation of audio content to be shared by the group of users, for example, based on an identified match between the merged profile for the group of users and the available audio share contents.

In some demonstrative aspects, BT audio sharing group recommendation mechanism 600 may be configured to extract at a given time t for a specific user A having a user profile BT-Audio-Share-User-Profile_{user A}, for example, one or more users, e.g., all users at the vicinity of the user A, who are listening to BT Audio Share content and are part of the BT audio Share community of the user A.

In some demonstrative aspects, BT audio sharing group recommendation mechanism 600 may be configured to extract, e.g., per each BT audio share content C, common features of all users that are currently listening to the content C, e.g., as BT-Audio-Users-Profile(t).

In some demonstrative aspects, BT audio sharing group recommendation mechanism 600 may be configured to determine group recommendations, and/or to adapt each content to the needs of the specific group of users who are listening, e.g., as described above.

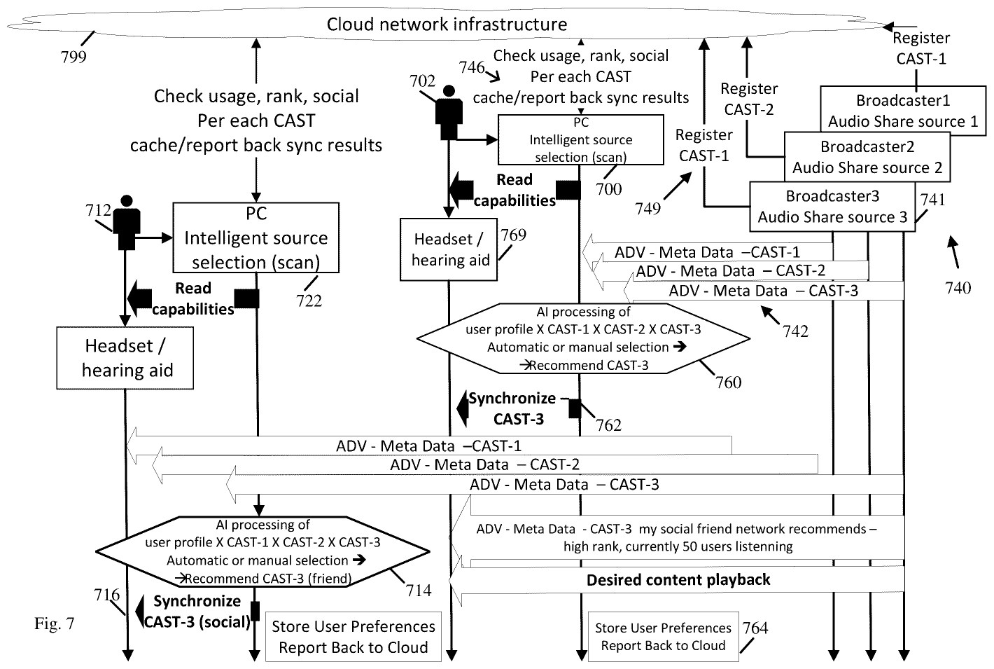

Reference is made to FIG. 7, which schematically illustrates operations and communications between BT devices, in accordance with some demonstrative aspects.

In some demonstrative aspects, as shown in FIG. 7, a BT device 700 may be configured to scan for broadcasts 742 from BT audio source devices 740. For example, the BT device 700 may include a computing device, e.g., a mobile computing device, smartphone, or the like, which may be connected to, or associated with, an audio sink device 769, e.g., a headset, an earphone, a hearing aid, or the like. In one example, controller 124 (FIG. 1) may be configured to control, cause, instruct and/or trigger device 102 (FIG. 1) to perform one or more operations and/or functionalities of the BT device 700.

In some demonstrative aspects, as shown in FIG. 7, the broadcasts 742 from BT audio source devices 740 may include a set of metadata attributes, which may be configured to support BT audio source selection at BT device 700.

For example, as shown in FIG. 7, a BT audio source device 740, e.g., each of the BT audio source devices 740 or only some of the BT audio source devices 740, may register (549) a CAST for the BT audio source device 740, for example, at a server 799, e.g., a cloud server. In one example, controller 174 (FIG. 1) may be configured to control, cause, instruct and/or trigger server 199 (FIG. 1) to perform one or more operations and/or functionalities of the server 799.

For example, as shown in FIG. 7, a broadcast 742 from a BT audio source device 740, e.g., each of the BT audio source devices 740 or only some of the BT audio source devices 740, may include a metadata attribute including the CAST to advertise the metadata on the audio content broadcasted by the BT audio source device 740, e.g., as described above.

In some demonstrative aspects, at least part of the metadata of the BT audio source device 740 may be provided as part of one or more metadata attributes in the broadcast 742.

In some demonstrative aspects, the BT device 700 may be configured to identify in the broadcast messages 742 from the BT audio source devices 740 metadata indicating attributes of audio data broadcasted by the BT audio source devices 740. For example, the BT device 700 may identify the CASTs in the broadcast messages 742 from the BT audio source devices 740.

In some demonstrative aspects, as shown in FIG. 7, the BT device 700 may retrieve data 746 corresponding to the detected BT audio source devices 740.

For example, as shown in FIG. 7, the BT device 700 may retrieve data 746 from server 799, for example, based on the metadata in the broadcasts 742, e.g., based on the CASTs in the broadcasts 742.

In some demonstrative aspects, as shown in FIG. 7, the BT device 700 may be configured to select from the plurality of BT audio source devices 740 one or more recommended BT audio source devices for a BT audio connection.

In some demonstrative aspects, as shown in FIG. 7, the BT device 700 may be configured to select (560) the one or more recommended BT audio source devices, for example, based on the metadata in the broadcast messages, e.g., based on the CAST and/or any other metadata in the broadcast messages 742, and based on a user profile corresponding to a user 702 of the BT device 700.

For example, the BT device 700 may be configured to process, infer and sort through the data and intelligently select the content which may currently be relevant for the user 702, e.g., as described above.

For example, as shown in FIG. 7, the BT device 700 may select a BT audio source device 741, which may be determined to have a high rank for a criterion (“my social friend network recommends”) relating to content recommended based on social data of the user 702. For example, as shown in FIG. 7, the BT audio source device 741 may currently have 50 users listening to content broadcasted by the BT audio source device 741.

For example, as shown in FIG. 7, the BT device 700 may guide the audio sink device 769 to synchronize (562) to the selected BT audio source device 741. For example, the selection BT audio source device 741 for BT audio connection may be automatic or manual.

In some demonstrative aspects, as shown in FIG. 7, user preferences/interactions based on the selected BT audio source device 741 may be saved (564) towards future selection and/or inference.

In some demonstrative aspects, as shown in FIG. 7, a user 712, e.g., a co-worker and/or a friend of the user 700, may arrives to the same area of user 700.

In some demonstrative aspects, as shown in FIG. 7, a BT device 722 carried by the user 712 may be configured to scan for broadcasts 742 from BT audio source devices 740.

In some demonstrative aspects, as shown in FIG. 7, BT device 722 may also receive a recommendation from user 702, e.g., via the cloud network, to recommend the CAST-3 which belongs to BT audio source device 714.

In some demonstrative aspects, as shown in FIG. 7, BT device 722 may infer and recommend (714) to user 712 to connect to BT audio source device 714 with CAST-3, for example, based on the social recommendation from the user 702.

In some demonstrative aspects, as shown in FIG. 7, the user 712 may accept the recommendation, and may join (716) the same shared content from CAST-3.

In some demonstrative aspects, as shown in FIG. 7, user preferences, e.g., some or all user preferences, may be stored on a database of the BT device 722, and may be uploaded to the cloud server 799, for example, for enhancing the recommendation and/or training the cloud server 799 with respect to the preferred BT audio source device 741, which is preferred by the user 702 and the user 712.

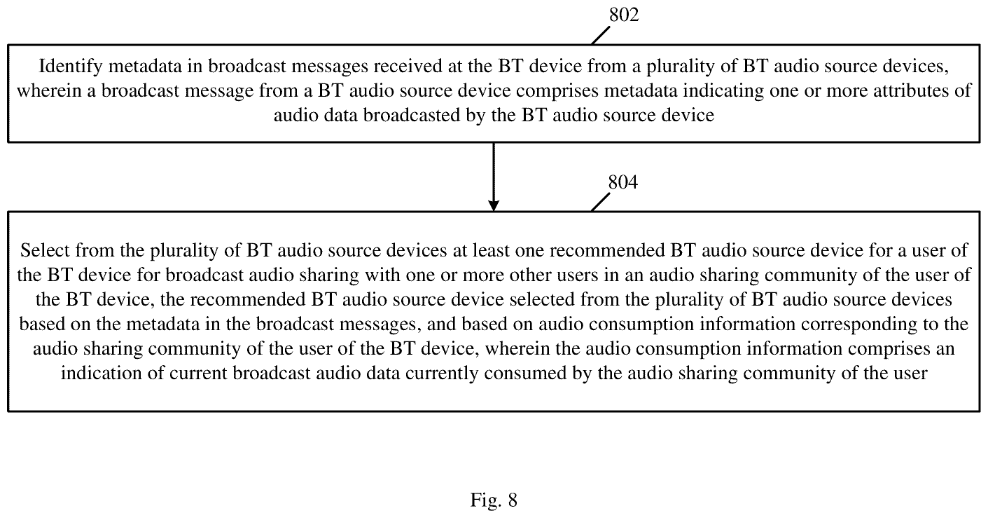

Reference is made to FIG. 8, which schematically illustrates a method of BT audio sharing, in accordance with some demonstrative aspects. For example, one or more of the operations of the method of FIG. 8 may be performed by one or more elements of a system, e.g., system 100 (FIG. 1), by a BT device, e.g., BT device 102 (FIG. 1), a server, e.g., server 199 (FIG. 1), and/or a controller, e.g., controller 124 (FIG. 1) and/or controller 174 (FIG. 1).

As indicated at block 802, the method may include identifying metadata in broadcast messages received at a BT device from a plurality of BT audio source devices. For example, a broadcast message from a BT audio source device may include metadata indicating one or more attributes of audio data broadcasted by the BT audio source device. For example, controller 124 (FIG. 1) may be configured to identify metadata in broadcast messages received at the BT device 102 (FIG. 1) from the plurality of BT audio source devices 143 (FIG. 1), e.g., as described above.

As indicated at block 804, the method may include selecting from the plurality of BT audio source devices at least one recommended BT audio source device for a user of the BT device for broadcast audio sharing with one or more other users in an audio sharing community of the user of the BT device. For example, the recommended BT audio source device may be selected from the plurality of BT audio source devices based on the metadata in the broadcast messages, and based on audio consumption information corresponding to the audio sharing community of the user of the BT device. For example, the audio consumption information may include an indication of current broadcast audio data currently consumed by the audio sharing community of the user, e.g., as described above. For example, controller 124 (FIG. 1) may be configured to select from the plurality of BT audio source devices 143 (FIG. 1) at least one recommended BT audio source device for a user of the BT device 102 (FIG. 1) for broadcast audio sharing with one or more other users in an audio sharing community of the user of the BT device 102 (FIG. 1), e.g., as described above.

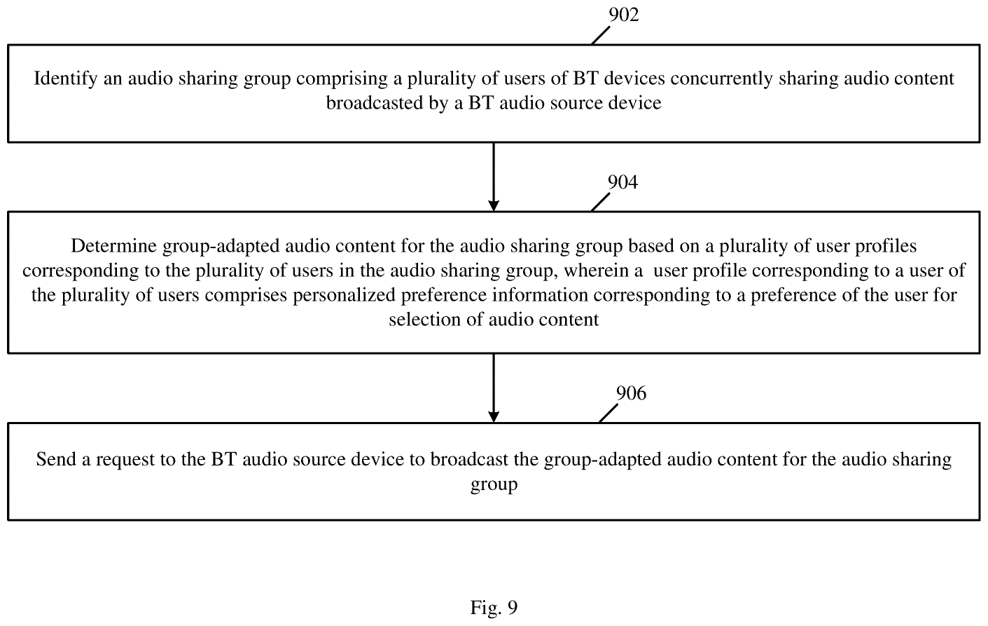

Reference is made to FIG. 9, which schematically illustrates a method of BT audio sharing, in accordance with some demonstrative aspects. For example, one or more of the operations of the method of FIG. 9 may be performed by one or more elements of a system, e.g., system 100 (FIG. 1), by a BT device, e.g., BT device 102 (FIG. 1), a server, e.g., server 199 (FIG. 1), and/or a controller, e.g., controller 124 (FIG. 1) and/or controller 174 (FIG. 1).

As indicated at block 902, the method may include identifying an audio sharing group including a plurality of users of BT devices concurrently sharing audio content broadcasted by a BT audio source device. For example, controller 174 (FIG. 1) may be configured to identify an audio sharing group including a plurality of users of BT devices concurrently sharing audio content broadcasted by a BT audio source device 143 (FIG. 1), e.g., as described above.

As indicated at block 904, the method may include determining group-adapted audio content for the audio sharing group based, for example, on a plurality of user profiles corresponding to the plurality of users in the audio sharing group. For example, a user profile corresponding to a user of the plurality of users may include personalized preference information corresponding to a preference of the user for selection of audio content. For example, controller 174 (FIG. 1) may be configured to determine group-adapted audio content for the audio sharing group based, for example, on the plurality of user profiles corresponding to the plurality of users in the audio sharing group, e.g., as described above.

As indicated at block 906, the method may include sending a request to the BT audio source device to broadcast the group-adapted audio content for the audio sharing group. For example, controller 174 (FIG. 1) may be configured to cause server 199 (FIG. 1) to send a request to the BT audio source device 143 (FIG. 1) to broadcast the group-adapted audio content for the audio sharing group, e.g., as described above.

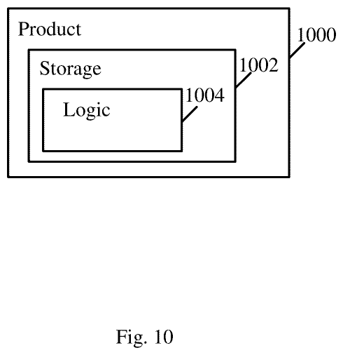

Reference is made to FIG. 10, which schematically illustrates a product of manufacture 1000, in accordance with some demonstrative aspects. Product 1000 may include one or more tangible computer-readable (“machine-readable”) non-transitory storage media 1002, which may include computer-executable instructions, e.g., implemented by logic 1004, operable to, when executed by at least one computer processor, enable the at least one computer processor to implement one or more operations at device 102 (FIG. 1), controller 124 (FIG. 1), server 199 (FIG. 1), and/or controller 174 (FIG. 1); to cause device 102 (FIG. 1), controller 124 (FIG. 1), server 199 (FIG. 1), and/or controller 174 (FIG. 1) to perform, trigger and/or implement one or more operations and/or functionalities; and/or to perform, trigger and/or implement one or more operations and/or functionalities described with reference to the FIGS. 1-9, and/or one or more operations described herein. The phrases “non-transitory machine-readable medium” and “computer-readable non-transitory storage media” may be directed to include all computer-readable media, with the sole exception being a transitory propagating signal.

In some demonstrative aspects, product 1000 and/or machine-readable storage media 1002 may include one or more types of computer-readable storage media capable of storing data, including volatile memory, non-volatile memory, removable or non-removable memory, erasable or non-erasable memory, writeable or re-writeable memory, and the like. For example, machine-readable storage media 1002 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 1004 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 1004 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising logic and circuitry configured to cause a Bluetooth (BT) device to identify metadata in broadcast messages received at the BT device from a plurality of BT audio source devices, wherein a broadcast message from a BT audio source device comprises metadata indicating one or more attributes of audio data broadcasted by the BT audio source device; and select from the plurality of BT audio source devices at least one recommended BT audio source device for a user of the BT device for broadcast audio sharing with one or more other users in an audio sharing community of the user of the BT device, the recommended BT audio source device selected from the plurality of BT audio source devices based on the metadata in the broadcast messages, and based on audio consumption information corresponding to the audio sharing community of the user of the BT device.

Example 2 includes the subject matter of Example 1, and optionally, wherein the apparatus is configured cause the BT device to select the recommended BT audio source device for broadcast audio sharing with at least one particular user in the audio sharing community of the user of the BT device based on a determined match between audio data broadcasted by the recommended BT audio source device and broadcast audio data currently consumed by the particular user.

Example 3 includes the subject matter of Example 1 or 2, and optionally, wherein the apparatus is configured cause the BT device to select the recommended BT audio source device for broadcast audio sharing with at least one particular user in the audio sharing community of the user of the BT device based on a determination that the particular user is currently consuming broadcast audio data from the recommended BT audio source device.

Example 4 includes the subject matter of any one of Examples 1-3, and optionally, wherein the apparatus is configured to identify, based on the audio consumption information, user count information to indicate a count of users in the audio sharing community of the user of the BT device currently listening to audio content from the BT audio source device, and to select the recommended BT audio source device from the plurality of BT audio source devices based on the user count information.

Example 5 includes the subject matter of any one of Examples 1-4, and optionally, wherein the apparatus is configured to cause the BT device to provide to the user of the BT device an audio sharing interface to interface between the user of the BT device and the one or more other users during a broadcast audio sharing session.

Example 6 includes the subject matter of Example 5, and optionally, wherein the audio sharing interface is configured to communicate one or more messages between the user of the BT device and the one or more other users during the broadcast audio sharing session.

Example 7 includes the subject matter of Example 6, and optionally, wherein the audio sharing interface comprises a graphic messaging interface to display the one or more messages communicated between the user of the BT device and the one or more other users during the broadcast audio sharing session.

Example 8 includes the subject matter of any one of Examples 5-7, and optionally, wherein the audio sharing interface is configured to input an invitation request from the user to indicate a user to be invited to the audio sharing session, and, based on the invitation request, to trigger an invitation message to be sent to the user to be invited to the audio sharing session.

Example 9 includes the subject matter of any one of Examples 1-8, and optionally, wherein the apparatus is configured to determine the audio sharing community of the user of the BT device based on a user profile corresponding to the user of the BT device, the user profile comprising personalized preference information corresponding to a preference of the user for selection of audio content.

Example 10 includes the subject matter of Example 9, and optionally, wherein the user profile comprises content information corresponding to audio content previously consumed by the user.

Example 11 includes the subject matter of Example 9 or 10, and optionally, wherein the user profile comprises collaborative content information corresponding to at least one of audio content previously shared by the user with another user, audio content previously recommended by the user, or audio content previously recommended to the user.

Example 12 includes the subject matter of any one of Examples 9-11, and optionally, wherein the user profile comprises social information corresponding to one or more other users socially associated with the user.

Example 13 includes the subject matter of any one of Examples 1-12, and optionally, wherein the apparatus is configured to select the recommended BT audio source device for audio sharing of the same broadcast audio content by the user of the BT device and the one or more other users in the audio sharing community of the user of the BT device.

Example 14 includes the subject matter of any one of Examples 1-13, and optionally, wherein the apparatus is configured to select the recommended BT audio source device for audio sharing of multiple streams of the same broadcast audio content by the user of the BT device and the one or more other users in the audio sharing community of the user of the BT device, wherein the multiple streams of the same broadcast audio content comprise at least a first stream of the broadcast audio content in a first language, and a second stream of the broadcast audio content in a second language.

Example 15 includes the subject matter of any one of Examples 1-14, and optionally, wherein the audio consumption information comprises an indication of current broadcast audio data consumed by the one or more other users in the audio sharing community of the user.

Example 16 includes the subject matter of any one of Examples 1-15, and optionally, wherein the apparatus is configured cause the BT device to automatically trigger establishment of the BT audio connection the BT device and the one or more recommended BT audio source devices.

Example 17 includes the subject matter of any one of Examples 1-16, and optionally, wherein the apparatus is configured cause the BT device to output to the user of the BT device an indication of the one or more recommended BT audio source devices.

Example 18 includes the subject matter of any one of Examples 1-17, and optionally, comprising a BT radio to receive the plurality of broadcast messages.

Example 19 includes the subject matter of Example 18, and optionally, comprising one or more antennas connected to the radio, and a processor to execute instructions of an operating system of the BT device.

Example 20 includes an apparatus comprising logic and circuitry configured to cause a server to identify an audio sharing group comprising a plurality of users of BT devices concurrently sharing audio content broadcasted by a BT audio source device; determine group-adapted audio content for the audio sharing group based on a plurality of user profiles corresponding to the plurality of users in the audio sharing group, wherein a user profile corresponding to a user of the plurality of users comprises personalized preference information corresponding to a preference of the user for selection of audio content; and send a request to the BT audio source device to broadcast the group-adapted audio content for the audio sharing group.

Example 21 includes the subject matter of Example 20, and optionally, wherein the apparatus is configured to cause the server to determine a language of the group-adapted audio content based on the plurality of user profiles.

Example 22 includes the subject matter of Example 20 or 21, and optionally, wherein the apparatus is configured to cause the server to determine a version of the group-adapted audio content based on the plurality of user profiles.

Example 23 includes the subject matter of any one of Examples 20-22, and optionally, wherein the apparatus is configured to cause the server to determine recommended audio content for the audio sharing group based on the plurality of user profiles, and to send to the plurality of users a recommendation to indicate the recommended audio content.

Example 24 includes the subject matter of any one of Examples 20-22, and optionally, wherein the apparatus is configured to cause the server to establish a broadcast audio sharing session for the plurality of users in the audio sharing group, and to communicate one or more messages between the plurality of users in the audio sharing group during the broadcast audio sharing session.

Example 25 includes the subject matter of Example 24, and optionally, wherein the apparatus is configured to cause the server to communicate an invitation request from a first user in the audio sharing group to a second user to be invited to the audio sharing session.

Example 26 includes the subject matter of any one of Examples 20-25, and optionally, wherein the apparatus is configured to cause the server to determine a recommended BT audio source device for the audio sharing group based on the plurality of user profiles, and to send to the plurality of users a recommendation to indicate the recommended BT audio source device.

Example 27 includes the subject matter of any one of Examples 20-26, and optionally, wherein the apparatus is configured to cause the server to identify a first audio sharing group comprising a first plurality of users of BT devices concurrently sharing at a first time period audio content broadcasted by the BT audio source device, to determine first group-adapted audio content for the first audio sharing group based on user profiles corresponding to the first plurality of users, and to send a first request to the BT audio source device to broadcast the first group-adapted audio content for the first audio sharing group; and identify a second audio sharing group comprising a second plurality of users of BT devices concurrently sharing at a second time period audio content broadcasted by the BT audio source device, to determine second group-adapted audio content for the second audio sharing group based on user profiles corresponding to the second plurality of users, and to send a second request to the BT audio source device to broadcast the second group-adapted audio content for the second audio sharing group.

Example 28 includes the subject matter of any one of Examples 20-27, and optionally, wherein the apparatus is configured to cause the server to identify a first audio sharing group comprising a first plurality of users of BT devices concurrently sharing audio content broadcasted by a first BT audio source device, to determine first group-adapted audio content for the first audio sharing group based on user profiles corresponding to the first plurality of users, and to send a first request to the first BT audio source device to broadcast the first group-adapted audio content for the first audio sharing group; and identify a second audio sharing group comprising a second plurality of users of BT devices concurrently sharing audio content broadcasted by a second BT audio source device, to determine second group-adapted audio content for the second audio sharing group based on user profiles corresponding to the second plurality of users, and to send a second request to the second BT audio source device to broadcast the second group-adapted audio content for the second audio sharing group.

Example 29 includes the subject matter of any one of Examples 20-28, and optionally, wherein the user profile comprises content information corresponding to audio content previously consumed by the user.

Example 30 includes the subject matter of any one of Examples 20-29, and optionally, wherein the user profile comprises collaborative content information corresponding to at least one of audio content previously shared by the user with another user, audio content previously recommended by the user, or audio content previously recommended to the user.

Example 31 includes the subject matter of any one of Examples 20-30, and optionally, wherein the user profile comprises social information corresponding to one or more other users socially associated with the user.

Example 32 includes the subject matter of any one of Examples 20-31, and optionally, comprising at least one communicate interface to communicate with the plurality of users and the BT audio source device.

Example 33 comprises an apparatus comprising means for executing any of the described operations of Examples 1-32.

Example 34 comprises a computing device configured to perform any of the described operations of Examples 1-32.

Example 35 comprises a product comprising one or more tangible computer-readable non-transitory storage media comprising instructions operable to, when executed by at least one processor, enable the at least one processor to cause any of the described operations of Examples 1-32.

Example 36 comprises an apparatus comprising: a memory interface; and processing circuitry configured to: perform any of the described operations of Examples 1-32.

Example 37 comprises a method comprising any of the described operations of Examples 1-32.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause a Bluetooth (BT) device to:
identify metadata in broadcast messages received at the BT device from a plurality of BT audio source devices, wherein a broadcast message from a BT audio source device comprises metadata indicating one or more attributes of audio data broadcasted by the BT audio source device; and
select from the plurality of BT audio source devices at least one recommended BT audio source device for a user of the BT device for broadcast audio sharing with one or more other users in an audio sharing community of the user of the BT device, the recommended BT audio source device selected from the plurality of BT audio source devices based on the metadata in the broadcast messages, and based on audio consumption information corresponding to the audio sharing community of the user of the BT device.

2. The apparatus of claim 1 configured cause the BT device to select the recommended BT audio source device for broadcast audio sharing with at least one particular user in the audio sharing community of the user of the BT device based on a determined match between audio data broadcasted by the recommended BT audio source device and broadcast audio data currently consumed by the particular user.

3. The apparatus of claim 1 configured cause the BT device to select the recommended BT audio source device for broadcast audio sharing with at least one particular user in the audio sharing community of the user of the BT device based on a determination that the particular user is currently consuming broadcast audio data from the recommended BT audio source device.

4. The apparatus of claim 1 configured to identify, based on the audio consumption information, user count information to indicate a count of users in the audio sharing community of the user of the BT device currently listening to audio content from the BT audio source device, and to select the recommended BT audio source device from the plurality of BT audio source devices based on the user count information.

5. The apparatus of claim 1 configured to cause the BT device to provide to the user of the BT device an audio sharing interface to interface between the user of the BT device and the one or more other users during a broadcast audio sharing session.

6. The apparatus of claim 5, wherein the audio sharing interface is configured to communicate one or more messages between the user of the BT device and the one or more other users during the broadcast audio sharing session.

7. The apparatus of claim 6, wherein the audio sharing interface comprises a graphic messaging interface to display the one or more messages communicated between the user of the BT device and the one or more other users during the broadcast audio sharing session.

8. The apparatus of claim 5, wherein the audio sharing interface is configured to input an invitation request from the user to indicate a user to be invited to the audio sharing session, and, based on the invitation request, to trigger an invitation message to be sent to the user to be invited to the audio sharing session.

9. The apparatus of claim 1 configured to determine the audio sharing community of the user of the BT device based on a user profile corresponding to the user of the BT device, the user profile comprising personalized preference information corresponding to a preference of the user for selection of audio content.

10. The apparatus of claim 9, wherein the user profile comprises collaborative content information corresponding to at least one of audio content previously shared by the user with another user, audio content previously recommended by the user, or audio content previously recommended to the user.

11. The apparatus of claim 9, wherein the user profile comprises social information corresponding to one or more other users socially associated with the user.

12. The apparatus of claim 1 configured to select the recommended BT audio source device for audio sharing of the same broadcast audio content by the user of the BT device and the one or more other users in the audio sharing community of the user of the BT device.

13. The apparatus of claim 1 configured to select the recommended BT audio source device for audio sharing of multiple streams of the same broadcast audio content by the user of the BT device and the one or more other users in the audio sharing community of the user of the BT device, wherein the multiple streams of the same broadcast audio content comprise at least a first stream of the broadcast audio content in a first language, and a second stream of the broadcast audio content in a second language.

14. The apparatus of claim 1, wherein the audio consumption information comprises an indication of current broadcast audio data consumed by the one or more other users in the audio sharing community of the user.

15. The apparatus of claim 1 configured cause the BT device to automatically trigger establishment of the BT audio connection the BT device and the one or more recommended BT audio source devices.

16. The apparatus of claim 1 configured cause the BT device to output to the user of the BT device an indication of the one or more recommended BT audio source devices.

17. The apparatus of claim 1 comprising a BT radio to receive the plurality of broadcast messages.

18. The apparatus of claim 17 comprising one or more antennas connected to the radio, and a processor to execute instructions of an operating system of the BT device.

19. A product comprising one or more tangible computer-readable non-transitory storage media comprising instructions operable to, when executed by at least one processor, enable the at least one processor to cause a Bluetooth (BT) device to:
identify metadata in broadcast messages received at the BT device from a plurality of BT audio source devices, wherein a broadcast message from a BT audio source device comprises metadata indicating one or more attributes of audio data broadcasted by the BT audio source device; and
select from the plurality of BT audio source devices at least one recommended BT audio source device for a user of the BT device for broadcast audio sharing with one or more other users in an audio sharing community of the user of the BT device, the recommended BT audio source device selected from the plurality of BT audio source devices based on the metadata in the broadcast messages, and based on audio consumption information corresponding to the audio sharing community of the user of the BT device.

20. The product of claim 19, wherein the instructions, when executed, cause the BT device to select the recommended BT audio source device for broadcast audio sharing with at least one particular user in the audio sharing community of the user of the BT device based on a determined match between audio data broadcasted by the recommended BT audio source device and broadcast audio data currently consumed by the particular user.

21. The product of claim 19, wherein the instructions, when executed, cause the BT device to provide to the user of the BT device an audio sharing interface to interface between the user of the BT device and the one or more other users during a broadcast audio sharing session.

22. An apparatus comprising logic and circuitry configured to cause a server to:
identify an audio sharing group comprising a plurality of users of BT devices concurrently sharing audio content broadcasted by a BT audio source device;
determine group-adapted audio content for the audio sharing group based on a plurality of user profiles corresponding to the plurality of users in the audio sharing group, wherein a user profile corresponding to a user of the plurality of users comprises personalized preference information corresponding to a preference of the user for selection of audio content; and
send a request to the BT audio source device to broadcast the group-adapted audio content for the audio sharing group.

23. The apparatus of claim 22 configured to cause the server to establish a broadcast audio sharing session for the plurality of users in the audio sharing group, and to communicate one or more messages between the plurality of users in the audio sharing group during the broadcast audio sharing session.

24. The apparatus of claim 22 configured to cause the server to:
identify a first audio sharing group comprising a first plurality of users of BT devices concurrently sharing at a first time period audio content broadcasted by the BT audio source device, to determine first group-adapted audio content for the first audio sharing group based on user profiles corresponding to the first plurality of users, and to send a first request to the BT audio source device to broadcast the first group-adapted audio content for the first audio sharing group; and
identify a second audio sharing group comprising a second plurality of users of BT devices concurrently sharing at a second time period audio content broadcasted by the BT audio source device, to determine second group-adapted audio content for the second audio sharing group based on user profiles corresponding to the second plurality of users, and to send a second request to the BT audio source device to broadcast the second group-adapted audio content for the second audio sharing group.

25. The apparatus of claim 22 configured to cause the server to:
identify a first audio sharing group comprising a first plurality of users of BT devices concurrently sharing audio content broadcasted by a first BT audio source device, to determine first group-adapted audio content for the first audio sharing group based on user profiles corresponding to the first plurality of users, and to send a first request to the first BT audio source device to broadcast the first group-adapted audio content for the first audio sharing group; and
identify a second audio sharing group comprising a second plurality of users of BT devices concurrently sharing audio content broadcasted by a second BT audio source device, to determine second group-adapted audio content for the second audio sharing group based on user profiles corresponding to the second plurality of users, and to send a second request to the second BT audio source device to broadcast the second group-adapted audio content for the second audio sharing group.
